(19) United States
(12) Patent Application Publication
(10) Pub. No.: US 2026/0333045 A1
(43) Pub. Date: Oct. 22, 2026

(54) AUTHORIZING SERVICES RELATED TO ARTIFICIAL INTELLIGENCE MACHINE LEARNING ENABLEMENT SPLIT OPERATION AND MODEL INFERENCE

(71) Applicant: Lenovo (United States) Inc., Morrisville, NC (US)

(72) Inventors: Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 19/390,144

(22) Filed: Nov. 14, 2025

(51) Int. Cl. H04W 12/08; H04W 12/06

(52) U.S. Cl. CPC H04W 12/08; H04W 12/068

(57) ABSTRACT

Various aspects of the present disclosure relate to authorizing services related to artificial intelligence machine learning enablement (AIMLE) split operation or model inference. A service device may transmit a first message requesting an access token including a scope related to an AIMLE split operation service or an AIMLE model inference service. The service device may receive, responsive to the first message, a second message including the access token, the access token including information that identifies one or more permissions for the AIMLE split operation service or the AIMLE model inference service.

### TECHNICAL FIELD

The present disclosure relates to wireless communications, and more specifically to authorizing services related to artificial intelligence machine learning enablement (AIMLE) split operation or model inference.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The device (e.g., service device or authorization device), processors, and methods of the present disclosure each have several innovative aspects, no single of which is solely responsible for the desirable features disclosed herein.

A service device (e.g., a UE or an NE) for wireless communication is described. The service device may be configured to, capable of, or operable to perform one or more operations as described herein. For example, the service device may be configured to, capable of, or operable to transmit a first message requesting an access token including a scope related to an AIMLE split operation service or an AIMLE model inference service and receive, responsive to the first message, a second message including the access token, the access token including information that identifies one or more permissions for the AIMLE split operation service or the AIMLE model inference service.

A processor (e.g., a standalone processor chipset, or a component of the service device) for wireless communication is described. The processor may be configured to, capable of, or operable to perform one or more operations as described herein. For example, the processor may be configured to, capable of, or operable to transmit a first message requesting an access token including a scope related to an AIMLE split operation service or an AIMLE model inference service and receive, responsive to the first message, a second message including the access token, the access token including information that identifies one or more permissions for the AIMLE split operation service or the AIMLE model inference service.

A method performed or performable by a service device for wireless communication is described. The method may include transmitting a first message requesting an access token including a scope related to an AIMLE split operation service or an AIMLE model inference service and receiving, responsive to the first message, a second message including the access token, the access token including information that identifies one or more permissions for the AIMLE split operation service or the AIMLE model inference service.

In some implementations, the service device, the processor, and the method may further be configured to, capable of, or operable to transmit a request to perform one or more operations related to the AIMLE split operation service or the AIMLE model inference service, the request including the access token and security credentials for authentication and authorization and receive a response that indicates whether the service device is authorized to perform the one or more operations.

In some implementations, responsive to the scope relating to the AIMLE split operation service and the AIMLE split operation service including a split operation discovery service, the first message includes expected split operation discovery filters, expected model information, expected usage information, expected quantity of nodes to support AIML operation splitting, audience as AIMLE server identifier (ID), or any combination thereof, and the information includes allowed split operation discovery filters, allowed model information, allowed usage information, allowed quantity of nodes to support AIML operation splitting, audience as AIMLE server ID, issuer as authorization device ID, or any combination thereof.

In some implementations, responsive to the scope relating to the AIMLE split operation service and the AIMLE split operation service including a split operation pipeline create, update, or delete service, the first message includes expected split operation requirements, expected usage information, expected notification target, expected stage information, expected head node, expected tail node, expected node information, split operation pipeline ID, audience as AIMLE server ID, or any combination thereof, and the information includes allowed split operation requirements, allowed usage information, allowed notification target, allowed head node, allowed tail node, allowed node information, the split operation pipeline ID, audience as AIMLE server ID, issuer as authorization device ID, or any combination thereof.

In some implementations, responsive to the scope relating to the AIMLE split operation service and the AIMLE split operation service including a split operation node registration, registration update, or de-registration service, the first message includes expected node information, expected split operation capabilities, expected usage information, expected lifetime for registration, registration ID, audience as AIMLE server ID, or any combination thereof, and the information includes allowed node information, allowed split operation capabilities, allowed usage information, allowed lifetime for registration, the registration ID, audience as AIMLE server ID, issuer as authorization device ID, or any combination thereof.

In some implementations, responsive to the scope relating to the AIMLE split operation service and the AIMLE split operation service including a split operation event subscription, subscription update, or unsubscription service, the first message includes an expected split operation pipeline ID, expected notification endpoint, expected event ID, expected split operation discovery filters, expected assistance information, expected lifetime for split operation subscription, subscription ID, audience as AIMLE server ID, or any combination thereof, and the information includes allowed split operation pipeline ID, allowed notification endpoint, allowed event ID, allowed split operation discovery filters, allowed assistance information, allowed lifetime for split operation subscription, the subscription ID, audience as AIMLE server ID, issuer as authorization device ID, or any combination thereof.

In some implementations, responsive to the scope relating to the AIMLE split operation service and the AIMLE split operation service including an AIMLE data management assistance subscription service, the first message includes expected list of AIMLE client IDs, expected list of client set IDs, expected data management operations per client ID, client set ID, or data set ID, expected client selection criteria, audience as AIMLE server ID, audience as AIMLE client IDs, expected list of target AIMLE client IDs or client set IDs, or any combination thereof, and the information includes allowed list of AIMLE client IDs, allowed list of client set IDs, allowed data management operations per client ID, client set ID, or data set ID, allowed client selection criteria, audience as AIMLE server ID, audience as AIMLE client IDs, allowed list of target AIMLE client IDs or client set IDs, issuer as authorization device ID, or any combination thereof.

In some implementations, responsive to the scope relating to the AIMLE split operation service and the AIMLE split operation service including a hierarchical computing assistance service, the first message includes expected list of vertical application layer (VAL) service IDs and corresponding expected permission levels, expected hierarchical roles for VAL server, expected computing task type, expected execution nodes, expected ML model ID list or expected ML model information for AIMLE client usage, expected hierarchical computing assistance mode, audience as edge AIMLE server ID, audience as central AIMLE server ID, or any combination thereof, and the information includes allowed list of VAL service IDs and corresponding allowed permission levels, allowed hierarchical roles for VAL server, allowed computing task type, allowed execution nodes, allowed ML model ID list or allowed ML model information for AIMLE client usage, allowed hierarchical computing assistance mode, audiences as edge AIMLE server ID, audience as central AIMLE server ID, issuer as authorization device ID, or any combination thereof.

In some implementations, responsive to the scope relating to the AIMLE model inference service, the first message includes expected list of VAL service IDs and corresponding expected permission levels, expected inference data type, expected inference data index, expected inference parameters, expected ML model ID, expected inference services, expected reporting types, expected address, expected ML model inference requirements, expected inference task, expected inference partitioning information, expected inference session IDs, audience as AIMLE server ID, or any combination thereof, and the information includes allowed list of VAL service IDs and corresponding allowed permission levels, allowed inference data type, allowed inference data index, allowed inference parameters, allowed ML model ID, allowed inference services, allowed reporting types, allowed address, allowed ML model inference requirements, allowed inference task, allowed inference partitioning information, allowed inference session IDs, audience as AIMLE server ID, issuer as authorization device ID, or any combination thereof. In some implementations, the service device includes one of an AIMLE client, an AIMLE server, a VAL client, or a VAL server.

An authorization device (e.g., an NE or a base station) for wireless communication is described. The authorization device may be configured to, capable of, or operable to perform one or more operations as described herein. For example, the authorization device may be configured to, capable of, or operable to receive a first message requesting an access token including a scope related to an AIMLE split operation service or an AIMLE model inference service, generate the access token including information that identifies one or more permissions for the AIMLE split operation service or the AIMLE model inference service, and transmit, responsive to the first message, a second message including the access token.

A processor (e.g., a standalone processor chipset, or a component of an authorization device) for wireless communication is described. The processor may be configured to, capable of, or operable to perform one or more operations as described herein. For example, the processor may be configured to, capable of, or operable to receive a first message requesting an access token including a scope related to an AIMLE split operation service or an AIMLE model inference service, generate the access token including information that identifies one or more permissions for the AIMLE split operation service or the AIMLE model inference service, and transmit, responsive to the first message, a second message including the access token.

A method performed or performable by an authorization device for wireless communication is described. The method may include receiving a first message requesting an access token including a scope related to an AIMLE split operation service or an AIMLE model inference service, generating the access token including information that identifies one or more permissions for the AIMLE split operation service or the AIMLE model inference service, and transmitting, responsive to the first message, a second message including the access token.

In some implementations, responsive to the scope relating to the AIMLE split operation service and the AIMLE split operation service including a split operation discovery service, the first message includes expected split operation discovery filters, expected model information, expected usage information, expected quantity of nodes to support AIML operation splitting, audience as AIMLE server ID, or any combination thereof, and the information includes allowed split operation discovery filters, allowed model information, allowed usage information, allowed quantity of nodes to support AIML operation splitting, audience as AIMLE server ID, issuer as authorization device ID, or any combination thereof.

In some implementations, responsive to the scope relating to the AIMLE split operation service and the AIMLE split operation service including a split operation pipeline create, update, or delete service, the first message includes expected split operation requirements, expected usage information, expected notification target, expected stage information, expected head node, expected tail node, expected node information, split operation pipeline ID, audience as AIMLE server ID, or any combination thereof, and the information includes allowed split operation requirements, allowed usage information, allowed notification target, allowed head node, allowed tail node, allowed node information, the split operation pipeline ID, audience as AIMLE server ID, issuer as authorization device ID, or any combination thereof.

In some implementations, responsive to the scope relating to the AIMLE split operation service and the AIMLE split operation service including a split operation node registration, registration update, or de-registration service, the first message includes expected node information, expected split operation capabilities, expected usage information, expected lifetime for registration, registration ID, audience as AIMLE server ID, or any combination thereof, and the information includes allowed node information, allowed split operation capabilities, allowed usage information, allowed lifetime for registration, the registration ID, audience as AIMLE server ID, issuer as authorization device ID, or any combination thereof.

In some implementations, responsive to the scope relating to the AIMLE split operation service and the AIMLE split operation service including a split operation event subscription, subscription update, or unsubscription service, the first message includes an expected split operation pipeline ID, expected notification endpoint, expected event ID, expected split operation discovery filters, expected assistance information, expected lifetime for split operation subscription, subscription ID, audience as AIMLE server ID, or any combination thereof, and the information includes allowed split operation pipeline ID, allowed notification endpoint, allowed event ID, allowed split operation discovery filters, allowed assistance information, allowed lifetime for split operation subscription, the subscription ID, audience as AIMLE server ID, issuer as authorization device ID, or any combination thereof.

In some implementations, responsive to the scope relating to the AIMLE split operation service and the AIMLE split operation service including an AIMLE data management assistance subscription service, the first message includes expected list of AIMLE client IDs, expected list of client set IDs, expected data management operations per client ID, client set ID, or data set ID, expected client selection criteria, audience as AIMLE server ID, audience as AIMLE client IDs, expected list of target AIMLE client IDs or client set IDs, or any combination thereof, and the information includes allowed list of AIMLE client IDs, allowed list of client set IDs, allowed data management operations per client ID, client set ID, or data set ID, allowed client selection criteria, audience as AIMLE server ID, audience as AIMLE client IDs, allowed list of target AIMLE client IDs or client set IDs, issuer as authorization device ID, or any combination thereof.

In some implementations, responsive to the scope relating to the AIMLE split operation service and the AIMLE split operation service including a hierarchical computing assistance service, the first message includes expected list of VAL service IDs and corresponding expected permission levels, expected hierarchical roles for VAL server, expected computing task type, expected execution nodes, expected ML model ID list or expected ML model information for AIMLE client usage, expected hierarchical computing assistance mode, audience as edge AIMLE server ID, audience as central AIMLE server ID, or any combination thereof, and the information includes allowed list of VAL service IDs and corresponding allowed permission levels, allowed hierarchical roles for VAL server, allowed computing task type, allowed execution nodes, allowed ML model ID list or allowed ML model information for AIMLE client usage, allowed hierarchical computing assistance mode, audiences as edge AIMLE server ID, audience as central AIMLE server ID, issuer as authorization device ID, or any combination thereof.

In some implementations, responsive to the scope relating to the AIMLE model inference service, the first message includes expected list of VAL service IDs and corresponding expected permission levels, expected inference data type, expected inference data index, expected inference parameters, expected ML model ID, expected inference services, expected reporting types, expected address, expected ML model inference requirements, expected inference task, expected inference partitioning information, expected inference session IDs, audience as AIMLE server ID, or any combination thereof, and the information includes allowed list of VAL service IDs and corresponding allowed permission levels, allowed inference data type, allowed inference data index, allowed inference parameters, allowed ML model ID, allowed inference services, allowed reporting types, allowed address, allowed ML model inference requirements, allowed inference task, allowed inference partitioning information, allowed inference session IDs, audience as AIMLE server ID, issuer as authorization device ID, or any combination thereof.

### BRIEF DESCRIPTION OF THE DRAWINGS

FIG. 1 illustrates an example of a wireless communications system in accordance with aspects of the present disclosure.

FIGS. 2 through 10 illustrate examples of process flows in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of an NE in accordance with aspects of the present disclosure.

FIG. 14 illustrates an example of a flowchart of a method performed by a service device in accordance with aspects of the present disclosure.

FIG. 15 illustrates an example of a flowchart of a method performed by an authorization device in accordance with aspects of the present disclosure.

### DETAILED DESCRIPTION

A wireless communications system may support an AIMLE split operation service (e.g., a split operation discovery service, a split operation pipeline create, update, or delete service, a split operation node registration, registration update, or de-registration service, a split operation event subscription, subscription update, or unsubscription service, an AIMLE data management assistance subscription service, or a hierarchical computing assistance service) or an AIMLE model inference service. Prior to initiating the AIMLE split operation service or the AIMLE model inference service, a service device (e.g., an AIMLE client, an AIMLE server, a VAL client, and a VAL server) may obtain an access token that the service device may then use to request the AIMLE split operation service or the AIMLE model inference service. The service device may obtain the access token by transmitting a request message to an authorization device. Subsequently, the service device may receive a response message that includes the access token from the authorization device.

However, in some wireless communications systems, authorization scope(s) within the request message may be optional and not well defined which may potentially lead to unauthorized devices performing the AIMLE split operation service or the AIMLE model inference service. One or more concerns related to unauthorized devices performing the AIMLE split operation service or the AIMLE model inference service may include split operation failures, targeted attacks over AIMLE clients, targeted attacks over processing nodes, service failures, unauthorized access to training data or sensitive information, consumption of paid compute resources resulting in financial loss, etc.

The techniques described herein provide fine-granularity authorization to secure the AIMLE split operation service or the AIMLE model inference service. In some examples, a service device may transmit an access token request message requesting an access token with a scope related to an AIMLE split operation service or an AIMLE model inference service. In response to the access token request message, the service device may receive an access token response message that includes the access token. In some examples, the access token may include information that identifies one or more permissions for the AIMLE split operation service or the AIMLE model inference service.

After obtaining the access token, the service device may use the access token to request the AIMLE split operation service or the AIMLE model inference service. For example, the service device may transmit a request to perform one or more operations related to the AIMLE split operation service or the AIMLE model inference service. The request may include the access token as well as security credentials for authentication and authorization. The service device may then receive a response that indicates whether the service device is authorized to perform the one or more operations.

It should be understood that various terms may be used interchangeably with “communicating,” such as “signaling,” “transmitting,” “receiving,” “outputting,” “forwarding,” “relaying,” “retrieving,” “obtaining,” and so forth. By performing the techniques described, the wireless communications system provides fine-granularity authorization of AIMLE services which may reduce or eliminate unauthorized devices from performing the AIMLE services.

Aspects of the present disclosure are described in the context of a wireless communications system. Additional aspects of the present disclosure are described in the context of component diagrams, process flows, method flows, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

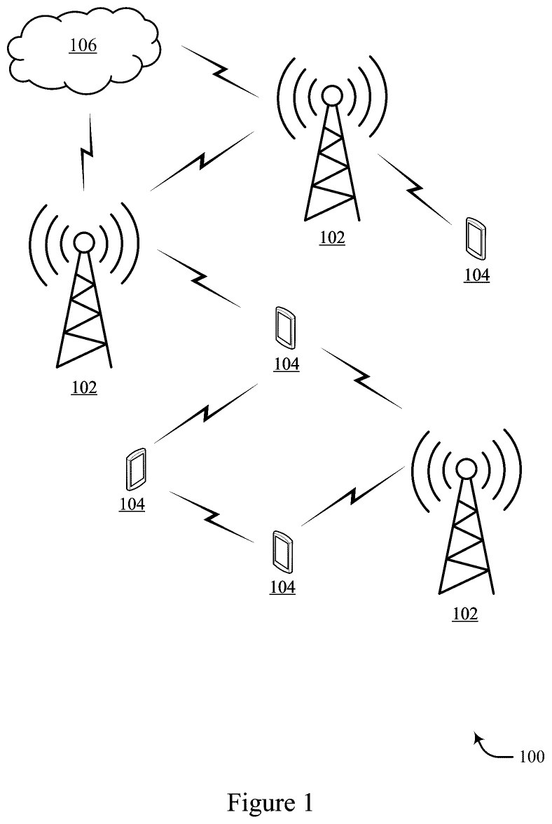

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHZ-114.25 GHz), FR4a or FR4-1 (52.6 GHZ-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support AIMLE. To support the AIMLE, devices of the wireless communications system 100 may include AIMLE functional entities. For example, the UE 104 may include a VAL client and an AIMLE client. Similarly, the network may include a VAL server and an AIMLE server. The VAL client may communicate with the VAL server over a VAL-UU interface which supports both unicast and multicast delivery modes. Further, the AIMLE client may communicate with the AIMLE server over an AIML-UU interface.

The AIMLE may include a common set of services for comprehensive enablement of AIMLE functionality including federate and distributed learning. Further, the AIMLE may provide AIMLE functionality to the VAL. For example, the AIMLE provides AIMLE functionality to the VAL client over an AIML-C interface, Further, the VAL server may communicate with the AIMLE server via the AIML-S interface. The AIMLE server may also interact with a ML repository over an AIML-R interface. The ML repository may serve as a repository for ML models and ML participants. Further, in some examples, the AIMLE server may be deployed as a service enabler architecture layer (SEAL) server in a SEAL framework.

AIMLE may also support off-network (or UE-to-UE) functionality. For off-network functionality, the VAL client of a first UE 104 may communicate with a VAL client of a second UE 104 over a VAL-PC5 interface which supports unicast and multicast delivery modes. In some examples, the first UE 104 may operate as a relay. That is, the first UE 104 may be connected to the network via a VAL-UU interface and thus enable the second UE 104 to access a VAL server of the network. Further, the AIMLE client of the first UE 104 may communicate with an AIMLE client of the second UE over the AIML-PC5 interface. The AIMLE client may provide functionality to a respective VAL client over the AIML-C interface. Such communication may be performed to support local ML operations (e.g., training, distribution, or inference) in a coordinated manner.

In some examples, split AIML operation (e.g., split operation) procedures enable applications consuming services from the AIML application enablement layer to discover and create instances of split operation pipeline and addresses aspects related to consumption of split operation result.

In an AIMLE framework, access tokens may be utilized to authorize communications between various network functions. That is, access tokens may serve as credentials used to authorize requests and/or authenticate a network function or device to access specific resources or information. Access tokens may include a set of claims, where claims include information regarding the access token itself, users, corresponding authorized or granted permissions, and so forth. The set of claims included in an access token may depend on a scope of the access token. The scope may provide a mechanism to limit access or permissions of a client (e.g., a requesting network function or device). In this way, the scope may restrict the range of requested access to particular claims.

According to implementations, one or more of the NEs 102 and the UEs 104 are operable to implement various aspects of the techniques described with reference to the present disclosure. For example, a service device (e.g., a UE 104 or an NE 102) may transmit a first message requesting an access token including a scope related to an AIMLE split operation service or an AIMLE model inference service and receive, responsive to the first message, a second message including the access token, the access token including information that identifies one or more permissions for the AIMLE split operation service or the AIMLE model inference service. An authorization device (e.g., an NE 102) may receive a first message requesting an access token including a scope related to an AIMLE split operation service or an AIMLE model inference service, generate the access token including information that identifies one or more permissions for the AIMLE split operation service or the AIMLE model inference service, and transmit, responsive to the first message, a second message including the access token.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

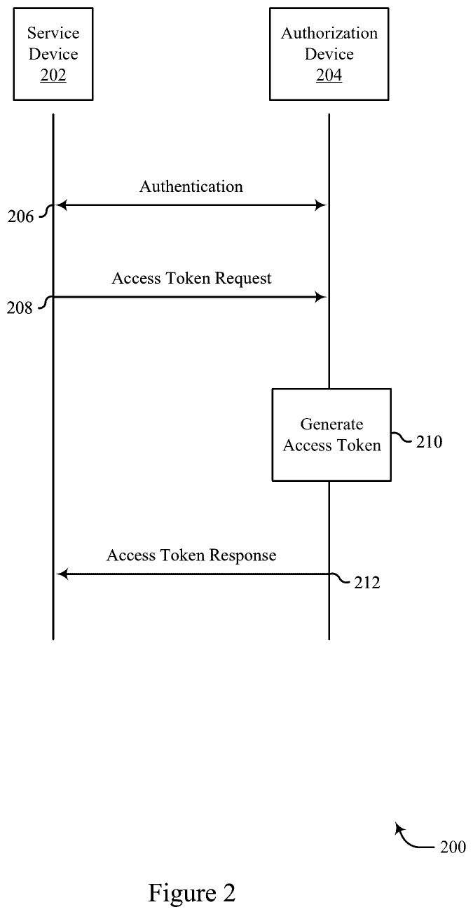

FIG. 2 illustrates an example of a process flow 200 in accordance with aspects of the present disclosure. The process flow 200 may be performed by a service device 202 and an authorization device 204.

At 206, the service device 202 may perform authentication with the authorization device 204. In some examples, the service device 202 may be an example of an AIMLE client, a VAL client, an AIMLE server, or a VAL server. The authorization device 204 may be an example of a service enabler architecture layer (SEAL) identity management server (SIM-S), an AIMLE server, a SEAL server, an AIMLE_IM server, or an AIMLE-SIM server.

At 208, the service device 202 may transmit an access token request (or a first message) to the authorization device 204. The access token request may request an access token that includes a scope related an AIMLE service (e.g., an AIMLE split operation service (e.g., a split operation discovery service, a split operation pipeline create, update, or delete service, a split operation node registration, registration update, or de-registration service, a split operation event subscription, subscription update, or unsubscription service, an AIMLE data management assistance subscription service, or a hierarchical computing assistance service) or an AIMLE model inference service (e.g., an AIML model inference exposure service or an AIML model inference discovery service)).

The access token request may include one or more information elements (IEs). For example, the access token request may include one or more of a scope IE, an audience IE, a cnonce IE, a req_cnf IE, or a resource owner ID IE. The scope IE may be an optional IE or a required IE and may request authorization scopes for the access token. The audience IE may be an optional IE and may request a specific authorization device 204 or resources for the access token. Additionally, the audience IE may request a specific device (e.g., AIMLE server ID or AIMLE service provider ID (e.g., AIMLE client/server ID)) for AIMLE-related service. The cnonce IE may be a required IE. The req_cnf IE may be an optional IE and may include information about a key that the service device 202 (or SEAL client) may bind to the access token for proof-of-possession. The resource owner ID IE may include an ID of a resource owner.

In some examples, the service device 202 may modify information or claims included in the scope IE based on the applicable AIMLE service. For example, Table 1 illustrates the information included in the scope IE if the applicable AIMLE service is a split operation discovery service. With reference to Table 1, the expected split operation discovery filters may include split operation stages (e.g., number or order). The expected model information may include ID versions. The expected usage information may include input frequency, input size, output frequency, or output size.

TABLE 1
Access Token Request

| Parameter | Value |
|---|---|
| Scope | OPTIONAL. This field requests authorization scope for the access token and |
| | AIMLE service-related information related to an AIMLE split operation service. |
| | Additionally, this field includes a split operation discovery service as scope, |
| | expected split operation discovery filters, expected model information, expected |
| | usage information, expected quantity of nodes to support AIML operation |
| | splitting, or audience as AIMLE server ID. |

Table 2 illustrates the information included in the scope IE if the applicable AIMLE service is a split operation pipeline create, update, or delete service. With reference to Table 2, the expected split operation requirements may include model information (e.g., ML model IDs or versions). The expected usage information may include input frequency, input size, output frequency, or output size. The expected notification target may include endpoint information. In some examples, the split operation pipeline ID may be included in the access token request for split operation pipeline update or delete service requests.

TABLE 2
Access Token Request

| Parameter | Value |
|---|---|
| Scope | OPTIONAL. This field requests authorization scope for the access token and |
| | AIMLE service-related information related to an AIMLE split operation service. |
| | Additionally, this field includes a split operation pipeline create, update, or delete |
| | service as scope, expected split operation requirements, expected usage |
| | information, expected notification target, expected stage information, expected |
| | head node, expected tail node, expected node information, split operation pipeline |
| | ID, or audience as AIMLE server ID. |

Table 3 illustrates the information included in the scope IE if the applicable AIMLE service is a split operation node registration, registration update, or de-registration service. With reference to Table 3, the expected node information may include information about the VAL server (e.g., ID or endpoints). An ID of the VAL server may be same as an ID of a service request (e.g., self-registration) or an ID of the VAL server may indicate an ID of a different VAL server. The expected split operation capabilities may include model information (e.g., ML model IDs or versions). The expected usage information may include input frequency, input size, output frequency, or output size. In some examples, the registration ID may be included in the access token request for registration update or de-registration service requests.

TABLE 3
Access Token Request

| Parameter | Value |
|---|---|
| Scope | OPTIONAL. This field requests authorization scope for the access token and |
| | AIMLE service-related information related to an AIMLE split operation service. |
| | Additionally, this field may include a split operation node registration, |
| | registration update, or de-registration service as scope, expected node |
| | information, expected split operation capabilities, expected usage information, |
| | expected lifetime for registration, registration ID, or audience as AIMLE server |
| | ID. |

Table 4 illustrates the information included in the scope IE if the applicable AIMLE service is a split operation event subscription, subscription update, or unsubscription service. With reference to Table 4, the expected notification endpoint may include a uniform resource locator (URL) address, uniform resource identifier (URI) address, or an internet protocol (IP) address. In some examples, the expected split operation discovery filters may include split operation stages (e.g., number or order). In some examples, the subscription ID is included in the access token request for split operation subscription update or unsubscribe service requests.

TABLE 4
Access Token Request

| Parameter | Value |
|---|---|
| Scope | OPTIONAL. This field requests authorization scope for the access token and |
| | AIMLE service-related information related to an AIMLE split operation service. |
| | Additionally, this field may include a split operation event subscription, |
| | subscription update, or unsubscription service as scope, an expected split |
| | operation pipeline ID, expected notification endpoint, expected event ID, |
| | expected split operation discovery filters, expected assistance information, |
| | expected lifetime for split operation subscription, subscription ID, or audience as |
| | AIMLE server ID. |

Table 5 illustrates the information included in the scope IE if the applicable AIMLE service is an AIMLE data management assistance subscription service. With reference to Table 5, the expected data management operations per client ID, client set ID, or data set ID may include data preparation (e.g., dataset ID, dataset feature ID, data preparation function ID, or executable ID) or data analysis (e.g., dataset ID, dataset feature ID, data preparation function ID, or executable ID).

TABLE 5
Access Token Request

| Parameter | Value |
|---|---|
| Scope | OPTIONAL. This field requests authorization scope for the access token and |
| | AIMLE service-related information related to an AIMLE split operation service. |
| | Additionally, this field may include an AIMLE data management assistance |
| | subscription service as scope, expected list of AIMLE client IDs, expected list of |
| | client set IDs, expected data management operations per client ID, client set ID, |
| | or data set ID, expected client selection criteria, audience as AIMLE server ID, |
| | audience as AIMLE client IDs, or expected list of target AIMLE client IDs or |
| | client set IDs. |

Table 6 illustrates the information included in the scope IE if the applicable AIMLE service is a hierarchical computing assistance service. With reference to Table 6, the expected hierarchical roles for VAL server include a root node, a sub-root node, or a leaf node of a hierarchical computing process. The expected computing take type may include vertical federated learning (VFL) or horizontal federated learning (HFL). The expected execution nodes may include one execution node or a list of execution nodes IDs. The expected hierarchical computing assistance mode may include a direct VAL server mode or indirect via edge AIMLE server controlled or assisted mode.

TABLE 6
Access Token Request

| Parameter | Value |
|---|---|
| Scope | OPTIONAL. This field requests authorization scope for the access token and |
| | AIMLE service-related information related to an AIMLE split operation service. |
| | Additionally, this field includes a hierarchical computing assistance service as |
| | scope, expected list of VAL service IDs and corresponding expected permission |
| | levels, expected hierarchical roles for VAL server, expected computing task type, |
| | expected execution nodes, expected ML model ID list or expected ML model |
| | information for AIMLE client usage, expected hierarchical computing assistance |
| | mode, audience as edge AIMLE server ID, or audience as central AIMLE server |
| | ID. |

Table 7 illustrates the information included in the scope IE if the applicable AIMLE service is an AIMLE model inference service (e.g., an AIML model inference exposure service or an AIML model inference discovery service). With reference to Table 7, the expected inference tasks may include a task type or task ID. For collaborative ML model inference, the access token request may include the expected inference partitioning information and the expected inference session IDs

TABLE 7
Access Token Request

| Parameter | Value |
|---|---|
| Scope | OPTIONAL. This field requests authorization scope for the access token and |
| | AIMLE service-related information related to an AIMLE model inference |
| | service. Additionally, this field may include an AIML model inference exposure |
| | service or an AIML model inference discovery service as scope, expected list of |
| | VAL service IDs and corresponding expected permission levels, expected |
| | inference data type, expected inference data index, expected inference |
| | parameters, expected ML model ID, expected inference services, expected |
| | reporting types, expected address, expected ML model inference requirements, |
| | expected inference task, expected inference partitioning information, expected |
| | inference session IDs, or audience as AIMLE server ID. |

At 210, the authorization device 204 may generate the access token in response to the access token request. In some examples, the authorization device 204 may generate the access token only if the access token request is valid and authorized by the authorization device 204. If the access token request is not valid and authorized, the authorization device 204 may return an error to the service device 202. In some examples, after generating the access token, the authorization device 204 may sign the access token with a public key. Signing the access token may ensure that information included in the access token is not altered during communication. Further, any device receiving the access token (e.g., an audience or verifier) may verify the issuer of the signed access token using the public key.

In some examples, the authorization device 204 may generate the access token based on the information included in the access token request. That is, the information included in the access token may differ depending on the information included in the scope IE of the access token request.

Table 8 illustrates the access token generated in response to the access token request related to the split operation discovery service.

TABLE 8

| Parameter | Value |
|---|---|
| Access | REQUIRED. This is the issued access token. The access token can include claims |
| Token | such as an ID of requester (e.g., VAL client ID, AIMLE client ID, VAL UE ID, |
| | or UE ID) as subject, a split operation discovery service as scope, allowed split |
| | operation discovery filters, allowed model information, allowed usage |
| | information, allowed quantity of nodes to support AIML operation splitting, |
| | audience as AIMLE server ID, or issuer as authorization device ID. |

Table 9 may illustrate the access token generated in response to the access token request related to the split operation pipeline create, update, or delete service.

TABLE 9

| Parameter | Value |
|---|---|
| Access | REQUIRED. This is the issued access token. The access token can include claims |
| Token | such as an ID of requester (e.g., VAL client ID, AIMLE client ID, VAL UE ID, |
| | or UE ID) as subject, a split operation pipeline create, update, or delete service as |
| | scope, allowed split operation requirements, allowed usage information, allowed |
| | notification target, allowed head node, allowed tail node, allowed node |
| | information, the split operation pipeline ID, audience as AIMLE server ID, or |
| | issuer as authorization device ID. |

Table 10 may illustrate the access token generated in response to the access token request related to the split operation node registration, registration update, or de-registration service.

TABLE 10

| Parameter | Value |
|---|---|
| Access | REQUIRED. This is the issued access token. The access token can include claims |
| Token | such as an ID of requester (e.g., VAL server ID, VAL client ID, AIMLE client |
| | ID, VAL UE ID, or UE ID) as subject, a split operation node registration, |
| | registration update, or de-registration service as scope, allowed node information, |
| | allowed split operation capabilities, allowed usage information, allowed lifetime |
| | for registration, the registration ID, audience as AIMLE server ID, or issuer as |
| | authorization device ID. |

Table 11 may illustrate the access token generated in response to the access token request related to the split operation event subscription, subscription update, or unsubscription service.

TABLE 11

| Parameter | Value |
|---|---|
| Access | REQUIRED. This is the issued access token. The access token can include claims |
| Token | such as an ID of requester (e.g., VAL server ID, VAL client ID, AIMLE client |
| | ID, VAL UE ID, or UE ID) as subject, a split operation event subscription, |
| | subscription update, or unsubscription service as scope, allowed split operation |
| | pipeline ID, allowed notification endpoint, allowed event ID, allowed split |
| | operation discovery filters, allowed assistance information, allowed lifetime for |
| | split operation subscription, the subscription ID, audience as AIMLE server ID, |
| | or issuer as authorization device ID. |

Table 12 may illustrate the access token generated in response to the access token request related to the AIMLE data management assistance subscription service.

TABLE 12

| Parameter | Value |
|---|---|
| Access | REQUIRED. This is the issued access token. The access token can include claims |
| Token | such as AIMLE service consumer ID as subject, an AIMLE data management |
| | assistance subscription service or client data processing trigger service as scope, |
| | allowed list of AIMLE client IDs, allowed list of client set IDs, allowed data |
| | management operations per client ID, client set ID, or data set ID, allowed client |
| | selection criteria, audience as AIMLE server ID, audience as AIMLE client IDs, |
| | allowed list of target AIMLE client IDs or client set IDs, or issuer as |
| | authorization device ID. |

Table 13 may illustrate the access token generated in response to the access token request related to the hierarchical computing assistance service.

TABLE 13

| Parameter | Value |
|---|---|
| Access | REQUIRED. This is the issued access token. The access token can include claims |
| Token | such as an ID of requester (e.g., VAL server ID and/or edge AIMLE server ID) as |
| | subject, a hierarchical computing assistance service as scope, allowed list of VAL |
| | service IDs and corresponding allowed permission levels, allowed hierarchical |
| | roles for VAL server, allowed computing task type, allowed execution nodes, |
| | allowed ML model ID list or allowed ML model information for AIMLE client |
| | usage, allowed hierarchical computing assistance mode, audiences as edge |
| | AIMLE server ID, audience as central AIMLE server ID, issuer as authorization |
| | device ID. |

Table 14 may illustrate the access token generated in response to the access token request related to the AIMLE model inference service.

TABLE 14

| Parameter | Value |
|---|---|
| Access | REQUIRED. This is the issued access token. The access token can include claims |
| Token | such as an ID of requester (e.g., VAL server ID, VAL client ID, AIMLE client |
| | ID, VAL UE ID, or UE ID) as subject, an AIML model inference service or ML |
| | model collaborative inference service as scope, allowed list of VAL service IDs |
| | and corresponding allowed permission levels, allowed inference data type, |
| | allowed inference data index, allowed inference parameters, allowed ML model |
| | ID, allowed inference services, allowed reporting types, allowed address, allowed |
| | ML model inference requirements, allowed inference task, allowed inference |
| | partitioning information, allowed inference session IDs, or audience as AIMLE |
| | server ID, issuer as authorization device ID. |

At 212, the authorization device 204 may transmit an access token response (or a second message) to the service device 202. The access token response may include one or more IEs. For example, the access token response may include one or more of an access token IE, an expire_in IE, a refresh_token IE, an ace_profile IE, a cnf IE, or an rs_cnf IE. The access token IE may be a required IE and may include the information presented in Tables 8-14. The expires_in IE may be a required IE and may include an indication of a lifetime of the access token in seconds. The refresh_token IE may be an optional IE and may include an issued refresh token. The ace_profile may be a required IE and may indicate an authentication and authorization for constrained environment (ACE) profile that the service device 202 (or SEAL client) may use towards the SEAL server or resource. The cnf IE may be an optional IE. The rs_cnf may be an optional IE.

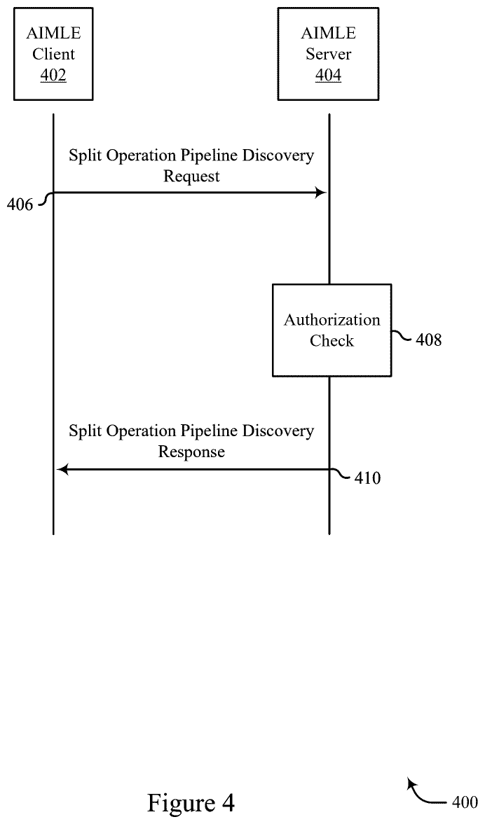

The service device 202 may now use the access token to make protected and authorized requests to a service producer (e.g., the AIMLE server, the VAL server, the AIMLE client, etc.). FIGS. 4-10 describe how the service device 202 may utilize the access token for different AIMLE services. Additionally, the various AIMLE security procedures described with reference to FIGS. 2 and 4-10 may also be applicable to a common application programming interface (API) framework (CAPIF). In such a CAPIF framework, an AIMLE client or a VAL UE may take a role of an API invoker residing as part of a UE, a VAL server may take a role of an API invoker residing as part of an application function (AF) or an application server, a SIM-S or an authorization server may take a role of a CAPIF, an AIMLE server may take a role of an API exposure function (AEF), and an ML repository may take a role of any function in the CAPIF framework.

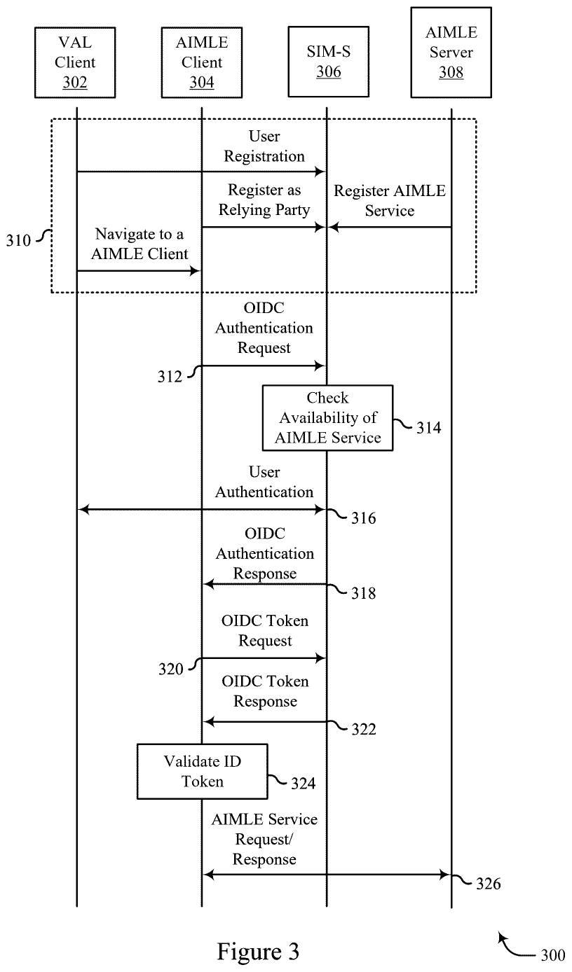

FIG. 3 illustrates an example of a process flow 300 in accordance with aspects of the present disclosure. The process flow 300 may be performed by a VAL client 302, an AIMLE client 304, a SIM-S 306, and an AIMLE server 308.

Steps 310-326 may describe an alternative method in which a service device (e.g., the AIMLE client 304) may obtain an access token for AIMLE services.

At 310, the AIMLE client 304 may register to the SIM-S 306 as a relying party and delegate identity management and user authentication to the SIM-S 306 which may take the role of OpenID provider. Further, AIMLE service may be registered to the SIM-S 306. The VAL client 302 may also register to the SIM-S 306 with a user profile and get User ID from the SIM-S 306. The VAL client 302 may navigate to the AIMLE client 304 with the User ID.

At 312, the AIMLE client 304 may transmit an OpenID connect (OIDC) authentication request to the SIM-S 306. The OIDC authentication request may include the User ID, GSPI, and response type. The scope of the OIDC authentication request may be set to OpenID and an AIMLE service (e.g., an AIMLE split operation service (e.g., a split operation discovery service, a split operation pipeline create, update, or delete service, a split operation node registration, registration update, or de-registration service, a split operation event subscription, subscription update, or unsubscription service, an AIMLE data management assistance subscription service, or a hierarchical computing assistance service) or an AIMLE model inference service (e.g., an AIML model inference exposure service or an AIML model inference discovery service)).

At 314, The SIM-S 306 may check if the AIMLE service is available. In addition, the SIM-S 306 may check if the AIMLE client 304 is allowed to access the AIMLE service according to local policy.

At 316, the SIM-S may trigger user authentication towards the VAL client 302 and obtain authorization from the VAL client 302 to allow the AIMLE client 304 to access the AIMLE service.

At 318, the SIM-S 306 may transmit an OIDC response to the AIMLE client 304 with an authentication code.

At 320, the AIMLE client 304 may transmit a token request to the SIM-S 306 with the authentication code. In some examples, the token request may include expected AIMLE service related information. For example, the token request may include scope information which may include any of the expected service-related information presented in Tables 1-7.

At 322, the SIM-S 306 may transmit a token response to the AIMLE client 304. The token response may include an ID token and an access token. The ID token may include an issuer ID set to the SIM-S 306, an audience ID set to AIMLE client 304, a subject ID set to User ID, a resource owner ID set to GPSI, and an expiration time. The access token may include an issuer ID set to the SIM-S 306, an audience ID set to the AIMLE server 308, a subject set to the User ID or VAL client ID, a resource owner ID set to GSPI, scope set to an AIMLE service, allowed service-related information, and an expiration time. The allowed service-related information may be any of the information presented in Tables 8-14. In some examples, the expiration time in the access token may be shorter than the one in the ID token.

At 324, the AIMLE client 304 may validate the ID token to authenticate the VAL client 302. Prior to any associated AIMLE service requests, secure connection may be established between the AIMLE client 304 and the AIMLE server 308.

At 326, the AIMLE client 304 may transmit an AIMLE service request to the AIMLE server 308 that includes the access token obtained at 322.

Upon receiving the AIMLE service request with the access token, the AIMLE server 308 may verify the access token and retrieve User ID or GPSI from the subject claim of the access token. The AIMLE server 308 may further check if the User ID or GPSI matches one of the owners or one of the uses or users in an AIMLE client profile of the allowed or accessed AIMLE service or resource. If yes, the AIMLE server 308 may further check if the requested operation is allowed by this user based on access control list of the AIMLE client profile of the allowed AIMLE service or resource. If yes, the AIMLE server 308 may perform the requested AIMLE service. Otherwise, AIMLE server 308 may reject the AIMLE service request. In some examples, access token verification includes verifying a digital signature of the access token, checking if the issuer is the SIM-S 306, audience is the AIMLE server 308, client ID matches the AIMLE client 304, scope is the requested AIMLE service, and the access token is not expired.

FIG. 4 illustrates an example of a process flow 400 in accordance with aspects of the present disclosure. The process flow 400 may be performed by an AIMLE client 402 and an AIMLE server 404.

Steps 406 through 410 may relate to a split operation pipeline discovery service. The split operation pipeline discovery service may enable the AIMLE client 402 to obtain information about available instances of split operation pipeline or processing nodes of interest. The discovery of the split operation pipeline or processing node instances is based on matching split operation discovery filters provided in a split operation pipeline discovery request. In some examples, prior to 406, the AIMLE client 402 may receive information (e.g., URI address or IP address) related to the AIMLE server 404 and receive an access token from an authorization server as described in FIG. 2. The access token may include some or all of the information presented in Table 8.

At 406, the AIMLE client 402 may transmit the split operation pipeline discovery request to the AIMLE server 404. The split operation pipeline discovery request may include security credentials (e.g., client certificates and/or root certificate to validate the client certificate) and the access token. The split operation pipeline discovery request may also include a requester ID and split operation discovery filters (e.g., stage information, model information, usage information, or number of nodes).

At 408, the AIMLE server 404 may validate the split operation pipeline discovery request and perform an authentication and authorization check based on the received security credentials and access token to determine if the AIMLE client 402 is authorized for the split operation pipeline discovery request. Upon successful authorization, the AIMLE server 404 may determine if existing instances of a split operation pipeline satisfy the split operation pipeline discovery request. If the AIMLE server 404 determines existing instances of a split operation pipeline, the AIMLE server 404 may proceed to 410. Otherwise, the AIMLE server 404 may determine if an instance of a split operation pipeline can be created. The determination for split operation pipeline creation is based on availability of ML models and determination of available processing nodes (e.g., VAL server(s) or network data analytics functions (NWDAFs)) to execute operations for such ML models (e.g., inference). VAL server nodes register with the AIMLE server 404 to indicate their availability and capabilities. If the AIMLE server 404 determines that the instance of a split operation pipeline can be created, the AIMLE server 404 creates a split operation profile. The split operation profile may include a split operation pipeline ID, a head endpoint, a tail endpoint, usage information, and stage information.

At 410, the AIMLE server 404 may transmit a split operation pipeline discovery response to the AIMLE client 402. If the AIMLE server 404 determines instances of a split operation pipeline (e.g., existing or new), the split operation pipeline discovery response may include an indication of success and include the corresponding split operation profiles as well as a list of discovered nodes. Otherwise, the split operation pipeline discovery response may include an indication of failure and a reason for the failure.

Upon receiving the split operation pipeline discovery response including the split operation profiles, the AIMLE client 402 may store the discovery split operation profiles. The AIMLE client 402 may provide split operation profile information (e.g. endpoints, usage, etc.) to VAL clients. The VAL clients may use the provided information to access the split operation pipeline. If a VAL client is a data provider, the VAL client may use the endpoint information to send data (e.g., intermediate inference data) towards the split operation pipeline instance's head endpoint. If the VAL client is a data consumer, the VAL client may use the endpoint information to request results or subscribe to results from the split operation pipeline instance's tail endpoint.

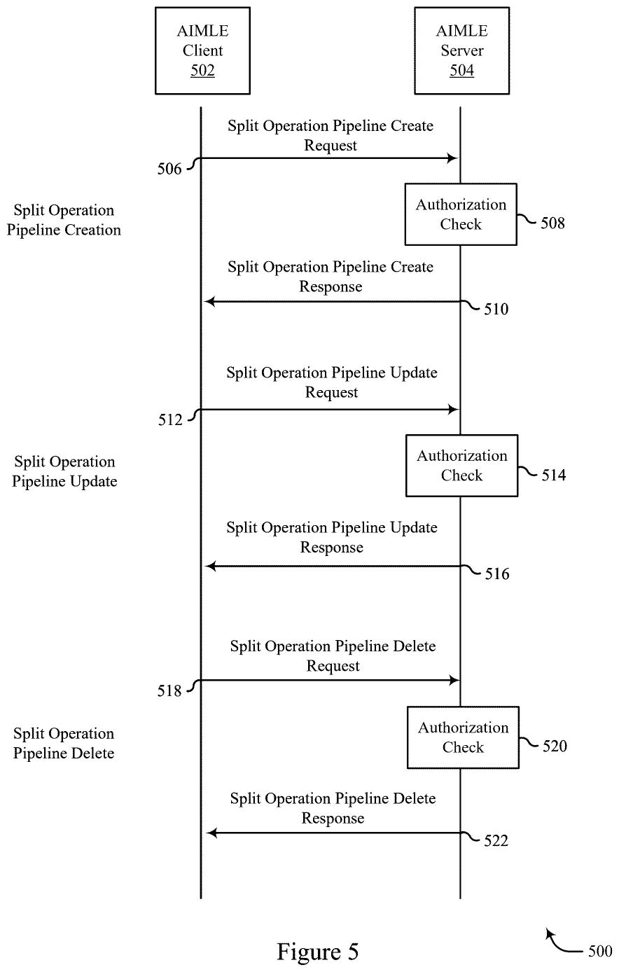

FIG. 5 illustrates an example of a process flow 500 in accordance with aspects of the present disclosure. The process flow 500 may be performed by an AIMLE client 502 and an AIMLE server 504.

Steps 506 through 510 may relate to a split operation pipeline creation service. The split operation pipeline creation service may enable the AIMLE client 502 to create an instance of a split operation pipeline. The creation of an instance of a split operation pipeline is based on discovery of available ML models and processing nodes. In some examples, prior to 506, the AIMLE client 502 may receive information (e.g., URI address or IP address) related to the AIMLE server 504. Additionally, prior to 506, the AIMLE client 502 may receive an access token from an authorization server as described in FIG. 2. The access token may include some or all of the information presented in Table 9. Moreover, the AIMLE client 502 may obtain discovery information about processing nodes available with the AIMLE server 504. In some examples, a VAL client and the AIMLE client 502 may select the nodes which may take part in a split operation and determine an order in which the nodes may perform split operation inference.

At 506, the AIMLE client 502 may transmit a split operation pipeline create request to an AIMLE server 504. The split operation pipeline create request may include security credentials (e.g., client certificates and/or root certificate to validate the client certificate) and the access token. Further, the split operation pipeline create request may include a requester ID and split operation requirements (e.g., model information, usage information, notification target, and stage information).

At 508, the AIMLE server 504 may perform authentication and authorization checks based on the security credentials and the access token to determine if the requestor is authorized for the split operation pipeline create request. If the requestor is authorized, the AIMLE server 504 may validate if the requested split operation pipeline can be created based on the information included in the split operation pipeline create request.

If the requestor is authorized and the AIMLE server 504 determines that an instance of a split operation pipeline can be created, the AIMLE server 504 may create a split operation profile along with an ID and notify the appropriate processing nodes indicated in the split operation pipeline create request about the inclusion of the split operation pipeline.

At 510, the AIMLE server 504 may transmit a split operation pipeline create response to the AIMLE client 502. If the AIMLE server 504 creates an instance of a split operation pipeline, the split operation pipeline create response may include an indication of success and the corresponding split operation profile. Otherwise, the split operation pipeline create response may include an indication of failure and may include a reason for the failure.

Steps 512 through 516 may relate to a split operation pipeline update service. The split operation pipeline update service may enable the AIMLE client 502 to manage instances of a split operation pipeline. In some examples, the AIMLE client 502 may determine that some of the nodes in the split operation pipeline may be unable to perform the required operation and decide to modify the pipeline by adding or removing the nodes. In some examples, prior to 512, the AIMLE client 502 may receive an access token from an authorization server as described in FIG. 2. The access token may include some or all of the information presented in Table 9. Moreover, the AIMLE client 502 may obtain information related to a split operation pipeline profile.

At 512, the AIMLE client 502 may transmit a split operation pipeline update request to the AIMLE server 504. The split operation pipeline update request may include security credentials (e.g., client certificates and/or root certificate to validate the client certificate) and the access token. Further, the split operation pipeline update request may include a requester ID, a split operation pipeline ID, and split operation pipeline information.

At 514, the AIMLE server 504 may perform authentication and authorization checks based on the security credentials and the access token to determine if the requestor is authorized for the split operation pipeline update request. If the requestor is authorized, the AIMLE server 504 may determine the requested split operation pipeline can be updated based on the split operation pipeline ID included in the split operation pipeline update request. If the requestor is authorized and a split operation pipeline profile is determined, the AIMLE server 504 may update the split operation pipeline profile and notify the appropriate processing nodes indicated in the split operation pipeline update request about their inclusion or exclusion in the split operation pipeline. The AIMLE server 504 may also notify the already existing nodes about the modification.

At 516, the AIMLE server 504 may transmit a split operation pipeline update response to the AIMLE client 502. If the AIMLE server 504 updates an instance of a split operation pipeline, the split operation pipeline update response may include an indication of success and the corresponding split operation profile. Otherwise, the split operation pipeline update response may include an indication of failure and a reason for the failure.

Steps 518 through 522 may relate to a split operation pipeline delete service. The split operation pipeline delete service may enable the AIMLE client 502 to manage instances of a split operation pipeline. In some examples, the AIMLE client 502 may determine to delete an instance of a split operation pipeline when it is no longer needed. In some examples, prior to 518, the AIMLE client 502 may receive an access token from an authorization server as described in FIG. 2. The access token may include some or all of the information presented in Table 9. Moreover, the AIMLE client 502 may obtain information related to a split operation pipeline profile.

At 518, the AIMLE client 502 may transmit a split operation pipeline delete request to the AIMLE server 504. The split operation pipeline delete request may include security credentials (e.g., client certificates and/or root certificate to validate the client certificate) and the access token. Further, the split operation pipeline delete request may include a requester ID and a split operation pipeline ID.

At 520, the AIMLE server 504 may perform authentication and authorization checks based on the security credentials and the access token to determine if the requestor is authorized for the split operation pipeline delete request. If the requestor is authorized, the AIMLE server 504 may determine whether the requested split operation pipeline can be deleted based on the split operation pipeline ID included in the split operation pipeline delete request. If the requestor is authorized and a split operation pipeline is determined, the AIMLE server 504 may delete the split operation pipeline profile and notify the appropriate processing nodes about the deletion.

At 522, the AIMLE server 504 may transmit a split operation pipeline delete response to the AIMLE client 502. If the AIMLE server 504 deletes an instance of a split operation pipeline, the split operation pipeline delete response may include an indication of success. Otherwise, the split operation pipeline delete response may include an indication of failure and a reason for the failure.

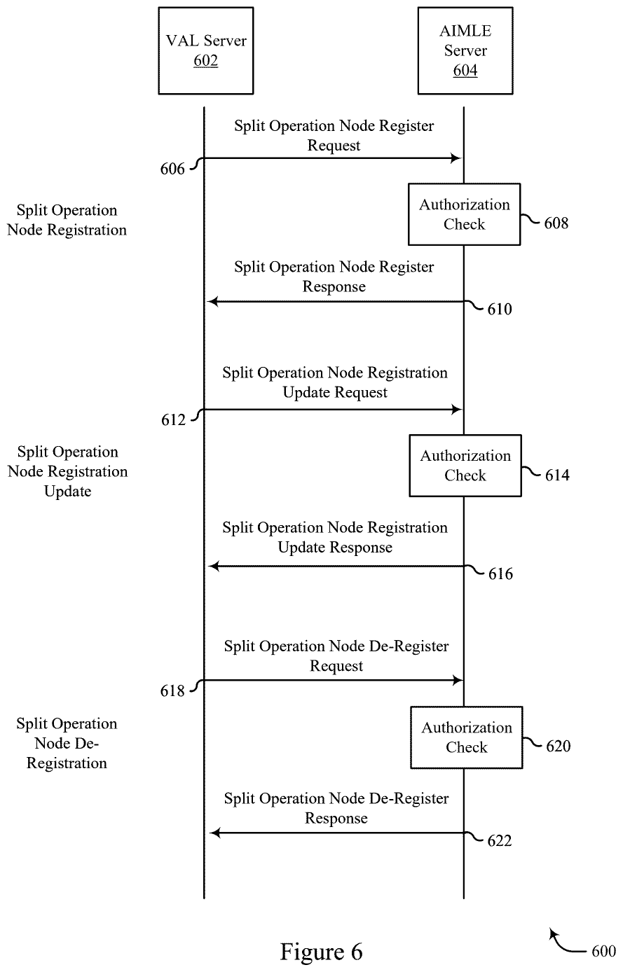

FIG. 6 illustrates an example of a process flow 600 in accordance with aspects of the present disclosure. The process flow 600 may be performed by a VAL server 602 and an AIMLE server 604.

Steps 606 through 610 may relate to a split operation node registration service. The split operation node registration service may enable a VAL server 602 to register with the AIMLE server 604 to indicate split operation capabilities. Registered VAL servers 602 may be notified by the AIMLE server 604 for participating in instances of a split operation pipeline. In some examples, prior to 606, the VAL server 602 may receive information (e.g., URI address or IP address) related to the AIMLE server 604. Further, prior to 606, the VAL server 602 may receive an access token from an authorization server as described in FIG. 2. The access token may include some or all of the information presented in Table 10.

At 606, the VAL server 602 may transmit a split operation node register request to the AIMLE server 604 to indicate split operation capabilities of the VAL server 602. The split operation node register request may include security credentials (e.g., client certificates and/or root certificate to validate the client certificate) and the access token. Further, the split operation node register request may include a requester ID, node information, split operation capabilities (e.g., model information or usage information), and an expiration time of the registration.

At 608, the AIMLE server 604 may perform authentication based on the security credentials and performs authorization checks by validating the access token claims to determine if the requestor is authorized for the split operation node register request. If the requestor is authorized, the AIMLE server 604 may store registration information associated with the VAL server 602.

At 610, the AIMLE server 604 may transmit a split operation node register response to the VAL server 602. If the AIMLE server 604 has registered the requestor, the split operation node register response may include an indication of success and may include an updated expiration time as well as a registration ID. In some examples, the requestor may send a registration update request before the expiration time to maintain the registration. Otherwise, the split operation node registration expires. If the requestor was not registered, the split operation node register response may include an indication of failure and a reason for the failure.

Steps 612 through 616 may relate to a split operation node registration update service. The split operation node registration update service may enable the VAL server 602 to update a split operation node registration with the AIMLE server 604. In some examples, prior to 612, the VAL server 602 may register with the AIMLE server 604. Further, prior to 612, the VAL server 602 may receive an access token from an authorization server as described in FIG. 2. The access token may include some or all of the information presented in Table 10.

At 612, the VAL server 602 may transmit a split operation node registration update request to the AIMLE server 604 to update an existing split operation registration. The split operation node registration update request may include security credentials (e.g., client certificates and/or root certificate to validate the client certificate) and the access token. Further, the split operation node registration update request may include a requester ID, node information, split operation capabilities (e.g., model information or usage information), and an expiration time of the registration.

At 614, the AIMLE server 604 may perform authentication based on the security credentials and performs authorization checks by validating the access token claims to determine if the requestor is authorized for the split operation node registration update request. If the requestor is authorized, the AIMLE server 604 may update the registration information associated with the VAL server 602.

At 616, the AIMLE server 604 may transmit a split operation node registration update response to the VAL server 602. If the AIMLE server 604 successfully updates the registration, the split operation node registration update response may include an indication of success and may include an updated expiration time. The requestor may send a registration update request before the expiration time to maintain the registration. Otherwise, the split operation registration expires. If the registration was not updated, the split operation node registration update response may include an indication of failure and a reason for the failure.

Steps 618 through 622 may relate to a split operation node de-registration service. The split operation node de-registration service may enable the VAL server 602 to de-register for a split operation with the AIMLE server 604. In some examples, prior to 618, the VAL server 602 may register with the AIMLE server 604. Further, prior to 618, the VAL server 602 may receive an access token from an authorization server as described in FIG. 2. The access token may include some or all of the information presented in Table 10.

At 618, the VAL server 602 may transmit a split operation node de-register request to the AIMLE server 604 to de-register from an existing split operation. The split operation node de-register request may include security credentials (e.g., client certificates and/or root certificate to validate the client certificate) and the access token. Further, the split operation node de-register request may include a requester ID.

At 620, the AIMLE server 604 may perform authentication based on the security credentials and performs authorization checks by validating the access token claims to determine if the requestor is authorized for the split operation node de-register request. If the requestor is authorized, the AIMLE server 604 may terminate the registration for the existing split operation.

At 622, the AIMLE server 604 may transmit a split operation node de-register response to the VAL server 602. If the AIMLE server 604 has successfully terminated the registration for the existing split operation node, the split operation node de-register response may include an indication of success. If the registration for the existing split operation was not terminated, the split operation node de-register response may include an indication of failure and may include a reason for failure.

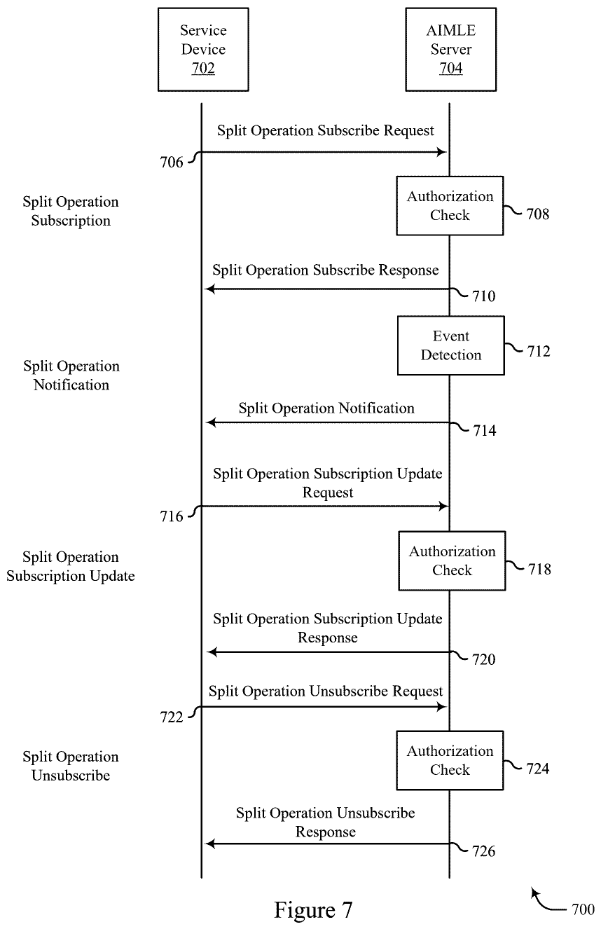

FIG. 7 illustrates an example of a process flow 700 in accordance with aspects of the present disclosure. The process flow 700 may be performed by a service device 702 (e.g., an AIMLE client or a VAL server) and an AIMLE server 704.

Steps 706 through 710 may relate to a split operation subscription service. The split operation subscription service may allow the service device 702 to receive notifications about split operation events. The subscription may be based on matching split discovery filters provided in a split operation subscribe request. In some examples, prior to 706, the service device 702 may receive information (e.g., URI address or an IP address) related to the AIMLE server 704. Further, prior to 706, the service device 702 may receive an access token from an authorization server as described in FIG. 2. The access token may include some or all of the information presented in Table 11.

At 706, the service device 702 may transmit a split operation subscribe request to the AIMLE server 704 to subscribe with the AIMLE server 704 to be notified of event related to split operations. The split operation subscribe request may include security credentials (e.g., client certificates and/or root certificate to validate the client certificate) and the access token. Further, the split operation subscribe request may include a requester ID, a split operation pipeline ID, a notification endpoint, an event ID (e.g., split operation pipeline information or split operation assistance information), discovery filters, assistance information, and an expiration time of the subscription.

In some examples, the requestor may include the split operation pipeline information event in the split operation subscribe request to indicate for the AIMLE server 704 to notify the requestor when a split operation profile is created or an existing pipeline is updated (e.g., a node is added or removed or stage order or ML models are modified) or deleted and satisfy the discovery filters of the split operation subscribe request. Additionally, or alternatively, the requestor may include the split operation assistance information event in the split operation subscribe request to indicate for the AIMLE server 704 to notify the requestor when the AIMLE server determines assistance information related to the split operation usage.

At 708, the AIMLE server 704 may perform authentication based on the security credentials and performs authorization checks by validating the access token claims to determine if the requestor is authorized for the split operation subscription request. If the requestor is authorized, the AIMLE server 704 may create the subscription and store subscription information.

At 710, the AIMLE server 704 may transmit a split operation subscription response to the service device 702. If the AIMLE server 704 creates the subscription, the split operation subscription response includes an indication of success, the subscription ID, and an expiration time. In some examples, to maintain the subscription, the requestor may transmit a subscription update request before the expiration time. Otherwise, the split operation subscription may expire. If the AIMLE server 704 does not create the subscription, the split operation subscription response includes an indication of failure and a reason for the failure.

If the subscription is for split operation assistance information, the AIMLE server 704 may consider the assistance information included in the split operation subscription request and perform the following operations. The AIMLE server 704 may aggregate assistance information obtained from network exposure function (NEF), NWDAF, and/or application data analytics enabler server (ADAES) to generate assistance information (e.g., time (e.g., time points or time windows) to deliver the task or data for the split operation). Additionally, or alternatively, the AIMLE server 704 may perform inference using ML models to generate the assistance information (e.g. achievable quality of service (QoS) with current configuration for task or data delivery or suggestion of QoS for task or data delivery).

To obtain the assistance information from the NEF, the AIMLE server 704 may send a request to the NEF for assistance information (e.g. planned data transfer with QoS requirements (PDTQ) on recommended time windows for AIML operations with QoS or QoS monitoring). The request may include the information of the AIML task or ML model or data (e.g., size of the task or ML model, or data volume), information of the receiving nodes, requirement on the delivery or distribution (e.g., time budget, time critical or not, QoS), or maximum time for complete the distribution or delivery. To obtain the assistance information from the NWDAF, the AIMLE server 704 may send a request or subscription request to the NWDAF for analytics (e.g., end-to-end (E2E) data volume transfer time, DN performance, Network performance, or UE mobility). To obtain the assistance information from the ADAES, the AIMLE server 704 may send a request or subscription request to the ADAES for analytics (e.g. slice-specific application performance analytics or UE-to-UE application performance analytics).

Steps 712 and 714 may relate to a split operation notification service. In some examples, prior to 712, the service device 702 may subscribe for split operation with the AIMLE server 704.

At 712, the AIMLE server 704 may detect one or more events that satisfy trigger conditions for notifying the service device 702 according to subscribed events.

If the subscribed event is split operation pipeline information and the AIMLE server 704 detects that a new split operation profile is created or an existing pipeline is updated or deleted and satisfies the discovery filters of the subscription, the AIMLE server 704 may notify the service device 702. If the subscribed event is split operation assistance information and the AIMLE server 704 determines assistance information related to split operation usage, the AIMLE server 704 may notify the service device 702.

At 714, The AIMLE server 704 may transmit a split operation notification to the service device 702 indicating the event. The split operation notification may include a subscription ID, a split operation profile, split operation node information, or split operation assistance information.

Steps 716 through 720 may relate to a split operation subscription update service. The split operation subscription update service may allow the service device 702 to update a subscription with the AIMLE server 704. In some examples, prior to 716, the service device 702 subscribes for split operation with the AIMLE server 704. Further, prior to 716, the service device 702 may receive an access token from an authorization server as described in FIG. 2. The access token may include some or all of the information presented in Table 11.

At 716, the service device 702 may transmit a split operation subscription update request to the AIMLE server 704 to update an existing subscription with the AIMLE server 704. The split operation subscription update request may include security credentials (e.g., client certificates and/or root certificate to validate the client certificate) and the access token. Further, the split operation subscription update request may include a subscription ID, a notification endpoint, an event ID (e.g., split operation pipeline information or split operation assistance information), discovery filters, and an expiration time of the subscription.

At 718, the AIMLE server 704 may perform authentication based on the security credentials and performs authorization checks by validating the access token claims to determine if the requestor is authorized for the split operation subscription update request. If the requestor is authorized, the AIMLE server 704 may update the subscription information.

At 720, the AIMLE server 704 may transmit a split operation subscription update response to the service device 702. If the AIMLE server 704 updates the subscription, the split operation subscription update response may include an indication of success and an expiration time. To maintain the subscription, the requestor may transmit a subscription update request before the expiration time. Otherwise, the split operation subscription expires. If the AIMLE server 704 does not update the subscription, the split operation subscription update response may include an indication of failure and a reason for the failure.

Steps 722 through 726 may relate to a split operation unsubscription service. The split operation unsubscription service may allow the service device 702 to unsubscribe with the AIMLE server 704. In some examples, prior to 722, the service device 702 subscribes for split operation with the AIMLE server 704. Further, prior to 722, the service device 702 may receive an access token from an authorization server as described in FIG. 2. The access token may include some or all of the information presented in Table 11.

At 722, the service device 702 may transmit a split operation unsubscribe request to the AIMLE server 704 to unsubscribe from an existing subscription with the AIMLE server 704. The split operation unsubscribe request may include security credentials (e.g., client certificates and/or root certificate to validate the client certificate) and the access token. Further, the split operation unsubscribe request may include a subscription ID.

At 724, the AIMLE server 704 may perform authentication based on the security credentials and performs authorization checks by validating the access token claims to determine if the requestor is authorized for the split operation unsubscribe request. If the requestor is authorized, the AIMLE server 704 may cancel the subscription associated with the subscription ID.

At 726, the AIMLE server 704 may transmit a split operation unsubscribe response to the service device 702. If the AIMLE server 704 cancels the subscription, the split operation unsubscribe response may include an indication of success. If the AIMLE server 704 does not cancel the subscription, the split operation unsubscribe response may include an indication of failure and a reason for the failure.

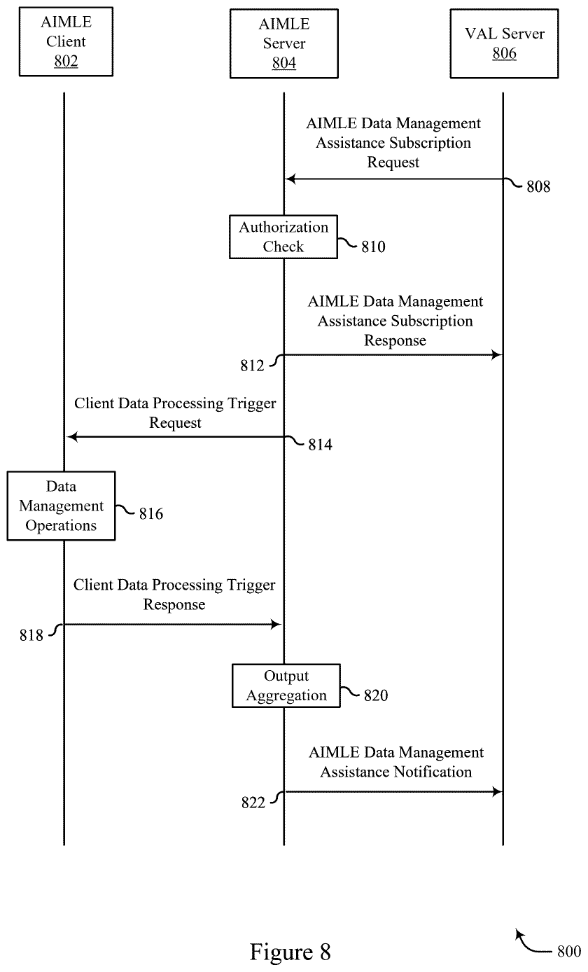

FIG. 8 illustrates an example of a process flow 800 in accordance with aspects of the present disclosure. In some examples, the process flow 800 may be performed by an AIMLE client 802, an AIMLE server 804, and a VAL server 806.

Steps 808 through 822 may relate to an AIMLE data management assistance subscription service. The AIMLE data management assistance subscription service includes a process where the AIMLE server 804 assists AIMLE service consumers with management of data operations performed by VAL clients. The data operations may include data preparation and data analysis. The AIMLE server 804 may offload the AIMLE service consumer from interacting with AIMLE clients 802 to manage the data operations. The VAL clients perform the actual data preparation and data analysis operations and may send outputs to the AIMLE server 804 for aggregation. In some examples, prior to 808, the AIMLE client 802 may register with the AIMLE server 804. Additionally, prior to 808, the VAL server 806 may receive an access token from an authorization server as described in FIG. 2. The access token may include some or all of the information presented in Table 12. Moreover, prior to 808, UE application data for AIML operations is collected and a dataset ID are assigned to each dataset.

At 808, the VAL server 806 transmits an AIMLE data management assistance subscription request to the AIMLE server 804. In some examples, the AIMLE data management assistance subscription request may include security credentials (e.g., client certificates and/or root certificate to validate the client certificate) and the access token. Further, the split operation unsubscribe request may include a requester ID, data management operations, data management requirements (e.g., data preparation requirements or data analysis requirements), AIMLE client list, and AIMLE client selection criteria.

At 810, the AIMLE server 804 may perform authentication based on the security credentials and performs authorization checks by validating the access token claims to determine if the requestor is authorized for the AIMLE data management assistance subscription request. If the requestor is authorized, the AIMLE server 804 may assign an ID for the subscription.

At 812, the AIMLE server 804 may transmit an AIMLE data management assistance subscription response to the VAL server 806. The AIMLE data management assistance subscription response may include a status, a subscription ID, and an expiration time for the subscription.

At 814, the AIMLE server 804 may transmit a client data processing trigger request to the AIMLE client 802 for data preparation and data analysis. In some examples, the client data processing trigger request may include security credentials (e.g., client certificates and/or root certificate to validate the client certificate) and the access token. Further, the client data processing trigger request may include a requester ID, a data management type, data management requirements (e.g., data preparation requirements or data analysis requirements), and an operational schedule.

At 816, the AIMLE client 802 may perform authentication based on the security credentials and performs authorization checks by validating the access token claims to determine if the AIMLE server 804 and the VAL server 806 are authorized for the client data processing trigger request. If the AIMLE server 804 and VAL server 806 are authorized, the AIMLE client 802 perform requested client data processing. In some examples, each AIMLE client 802 may transmit requirements to trigger data management for a VAL client to perform the requested data operation. The VAL client may perform the data operation locally. The data preparation and data analysis functions may operate in a similar manner as ML models. The AIMLE layer may transport the functions to the VAL clients and the VAL clients performs the associated function on the application data as part of data preparation or data analysis in a similar manner as ML training.

At 818, upon completing the data operation, the AIMLE client 802 transmits a client data processing trigger response to the AIMLE server 804. The client data processing trigger response may include data preparation outputs, data analysis outputs, and a timestamp of the data management operation.

At 820, the AIMLE server 804 may aggregate the data outputs received from the AIMLE clients 802. Aggregation may include combining or performing a statistical operation on the received data outputs. Data outputs received from the AIMLE clients 802 can be numerical or categorical, which allows the AIMLE server 804 to aggregate the data outputs from the AIMLE clients 802. In some examples, steps 814 through 820 may be repeated to complete all data operations.

At 822, the AIMLE server 804 may transmit an AIMLE data management assistance notification to the VAL server 806. In some examples, the AIMLE data management assistance notification may include the aggregated data preparation outputs, the aggregated data analysis outputs, and a timestamp of the data management notification.

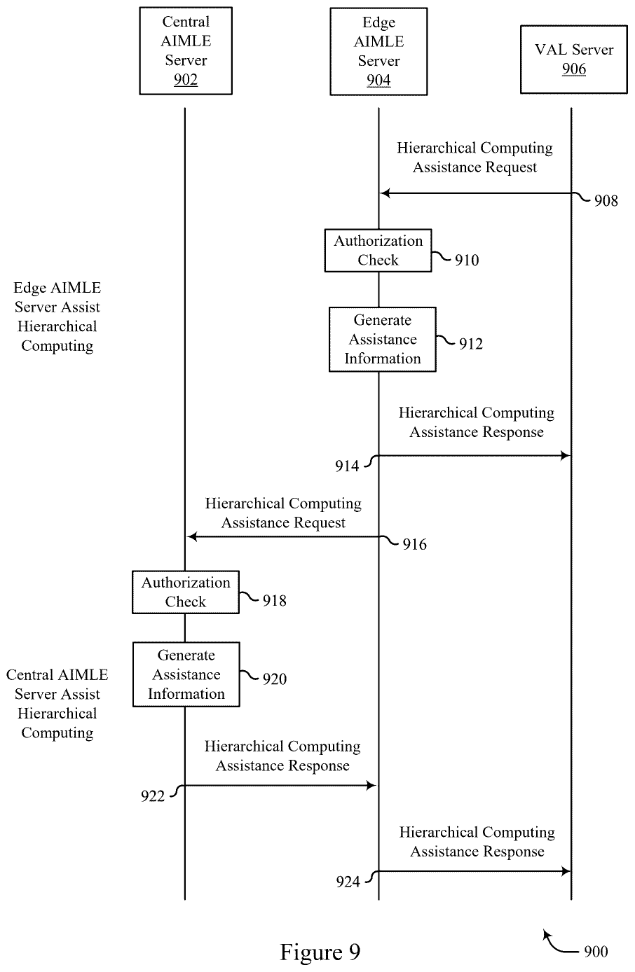

FIG. 9 illustrates an example of a process flow 900 in accordance with aspects of the present disclosure. In some examples, the process flow 900 may be performed by a central AIMLE server 902, an edge AIMLE server 904, and a VAL server 906 (e.g., CAS or EAS).

An entity (e.g. CAS or EAS) may have different roles in hierarchical computing (e.g., with a root node with one or more children (or sub-root node(s)) and multiple leaf nodes with no children). Hierarchical computing may represent a computation architecture with multiple computation entities involved and multiple levels of computations for a computation task.

Steps 908 through 914 may relate to an edge AIMLE server assisted hierarchical computing service which enable an edge AIMLE server 904 to assist a hierarchical computing process. In some examples, prior to 908, an AIML task is identified as a special computing task being completed by a VAL server 906. Further, prior to 908, the VAL server 906 may determine its role in the hierarchical computing architecture for the AIML task based on its local configuration. Moreover, prior to 908, the edge AIMLE server 904 or the central AIMLE server 902 may be configured to assist a hierarchical computing process by providing time windows recommendation for computing task distribution if the VAL server 906 is a root node in the hierarchical computing process, providing time windows recommendation for intermediate output delivery if the VAL server 906 is a leaf node in the hierarchical computing process, and providing candidate execution node list provisioning or computing preparation status provisioning. Further, prior to 908, the VAL server 906 may decide that assistance from edge AIMLE server 904 or the central AIMLE server 902 is needed (e.g., due to lack of capability). Additionally, prior to 908, the edge AIMLE server 904 or the central AIMLE server 902 may be deployed following a hierarchical deployment model. Further, prior to 908, the VAL server 906 may receive an access token from an authorization server as described in FIG. 2. The access token may include some or all of the information presented in Table 13.

At 908, the VAL server 906 may transmit a hierarchical computing assistance request to the edge AIMLE server 904 for a hierarchical computing process. In some examples, the hierarchical computing assistance request may include security credentials (e.g., client certificates and/or root certificate to validate the client certificate) and the access token. Further, the hierarchical computing assistance request may include a requester ID, original requester ID, role, computing task type, assistance information type, and execution nodes.

At 910, the edge AIMLE server 904 may perform authentication based on the security credentials and performs authorization checks by validating the access token claims to determine if the VAL server 906 is authorized for the hierarchical computing assistance request. If the VAL server 906 is authorized, the edge AIMLE server 904 may generate required assistance information (e.g., computing preparation status at an execution node which is registered to it). Further, the edge AIMLE server 904 may check its capability to provide the required assistance information. If the hierarchical computing assistance request is authorized but the edge AIMLE server 904 cannot generate the required assistance information (e.g. execution nodes are registered to different edge AIMLE servers), the edge AIMLE server 904 proceeds to 916.

At 912, the edge AIMLE server 904 may perform operations to generate the required assistance information. For example, for computing preparation status at an execution node, the edge AIMLE server 904 may subscribe or request analytics from an ADAE server (e.g. edge load analytics or edge computing preparation analytics) and aggregate the information received to generate the required assistance information.

At 914, the edge AIMLE server 904 sends a hierarchical computing assistance response to the VAL server 906. The hierarchical computing assistance response may include one or more of a success indicator, the required assistance information, the list of candidate execution nodes, and a preparation status, or a failure indicator.

At 916, if the edge AIMLE server 904 cannot generate the required assistance information, the edge AIMLE server 904 may transmit (or forward) the hierarchical computing assistance request to the central AIMLE server 902.

At 918, the central AIMLE server 902 may perform authentication based on the security credentials and performs authorization checks by validating the access token claims to determine if the VAL server 906 and the edge AIMLE server 904 are authorized for the hierarchical computing assistance request. If the VAL server 906 and the edge AIMLE server 904 are authorized, the central AIMLE server 902 may generate the required assistance information.

At 920, the central AIMLE server 902 may perform operations to generate the required assistance information. For example, for execution node selection, according to the role of the VAL server 906 in the hierarchical computing assistance request in 908, the central AIMLE server 902 may derive the requirements on the execution node (e.g. high computation capability, high communication capability, or both). The central AIMLE server 902 may then subscribe or request analytics from the ADAE server (e.g. edge load analytics or edge computing preparation analytics), trigger generation of split operation assistance information and retrieve FL member information from ML Repository (e.g., the FL member with EAS ID). Existing services may be reused for execution node selection.

At 922, the central AIMLE server 902 may transmit the hierarchical computing assistance response to the edge AIMLE server 904 and at 924, the edge AIMLE server 904 may forward the hierarchical computing assistance response to the VAL server 906. In some examples, the central AIMLE server 902 may transmit the hierarchical computing assistance response directly to the VAL server 906. The VAL server 906 may use the required assistance information included in the hierarchical computing assistance response for decision making on its computing operations. If the VAL server 906 knows information regarding the central AIMLE server 902, the VAL server 906 may send the hierarchical computing assistance request directly to the central AIMLE server 902 (e.g., as opposed to sending the hierarchical computing assistance request directly to the edge AIMLE server 904).

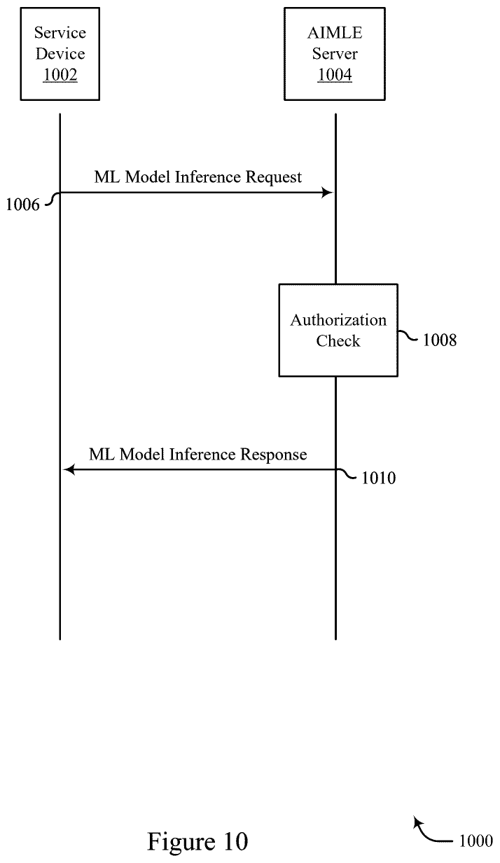

FIG. 10 illustrates an example of a process flow 1000 in accordance with aspects of the present disclosure. In some examples, the process flow 1000 may be performed by a service device 1002 (e.g., a VAL server or an AIMLE client) and an AIMLE server 1004.

Steps 1006 through 1010 may relate to an AIMLE model inference service. The AIMLE model inference service may enable a service device 1002 to request the AIMLE server 1004 for ML model inference by specifying details about the ML model or requirements to select the ML model. In some examples, prior to 1006, the ML model for ML model inference may be available to the AIMLE server 1004. Further, prior to 1006, the service device 1002 may receive an access token from an authorization server as described in FIG. 2. The access token may include some or all of the information presented in Table 14.

At 1006, the service device 1002 may transmit a ML model inference request to the AIMLE server 1004 requesting an inference result from the AIMLE server 1004. In some examples, the ML model inference request may include security credentials (e.g., client certificates and/or root certificate to validate the client certificate) and the access token. Further, the ML model inference request may include a requester ID, inference data, inference data index, inference parameters, ML model information, and ML model inference requirement information.

At 1008, the AIMLE server 1004 may perform authentication based on the security credentials and performs authorization checks by validating the access token claims to determine if the service device 1002 is authorized for the ML model inference request. If the service device 10002 is authorized, the AIMLE server 1004 may perform the ML model inference request. That is, the AIMLE server 1004 may execute the inference task. If no model information is provided but only the model inference requirement information is provided in the ML model inference request, the AIMLE server 1004 may identify and select the appropriate ML model for inference based on the ML model inference requirement information.

At 1010, the AIMLE server 1004 may transmit a ML model inference response to the service device 1002. If the AIMLE server 1004 performs the inference task, the ML model inference response may include an indication of success, the inference result, and ML model ID. If the AIMLE server 1004 does not perform the inference task, the ML model inference response may include an indication of failure and a reason for the failure. A similar procedure may be used for an AIML model inference discovery service.

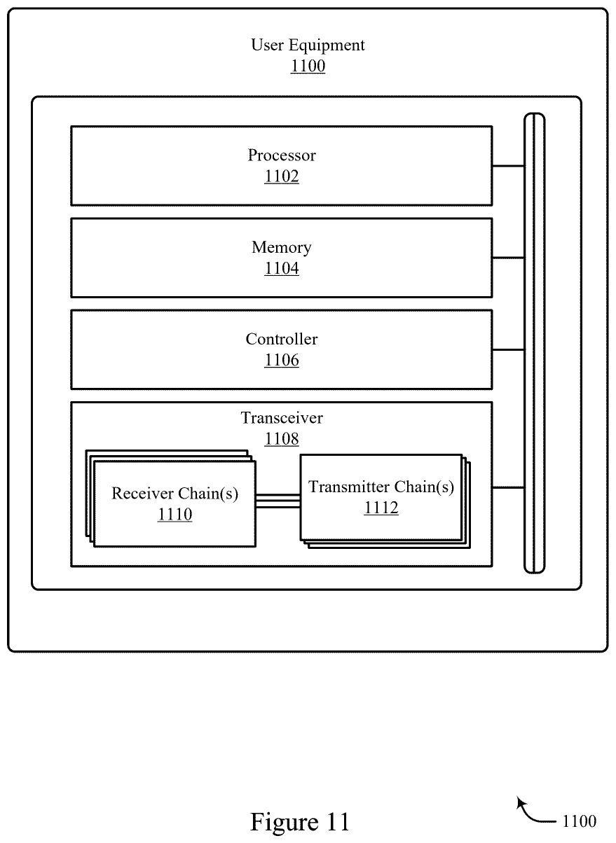

FIG. 11 illustrates an example of a UE 1100 in accordance with aspects of the present disclosure. In some examples, the UE 1100 may be an example of a UE as described with reference to FIG. 1. Further, the UE 1100 may be an example of a service device, an AIMLE client or a VAL client as described with reference to FIGS. 2 through 10. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to or operable to support a means for transmitting a first message requesting an access token including a scope related to an AIMLE split operation service or an AIMLE model inference service and receiving, responsive to the first message, a second message including the access token, the access token including information that identifies one or more permissions for the AIMLE split operation service or the AIMLE model inference service.

Additionally, or alternatively, the UE 1100 may support at least one memory (e.g., the memory 1104) and at least one processor (e.g., the processor 1102) coupled with the at least one memory and configured to cause the UE to transmit a first message requesting an access token including a scope related to an AIMLE split operation service or an AIMLE model inference service and receive, responsive to the first message, a second message including the access token, the access token including information that identifies one or more permissions for the AIMLE split operation service or the AIMLE model inference service.

Additionally, the UE 1100 may be configured to support any one or combination of the at least one processor configured to cause the UE 1100 to transmit a request to perform one or more operations related to the AIMLE split operation service or the AIMLE model inference service, the request including the access token and security credentials for authentication and authorization and receive a response that indicates whether the service device is authorized to perform the one or more operations.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

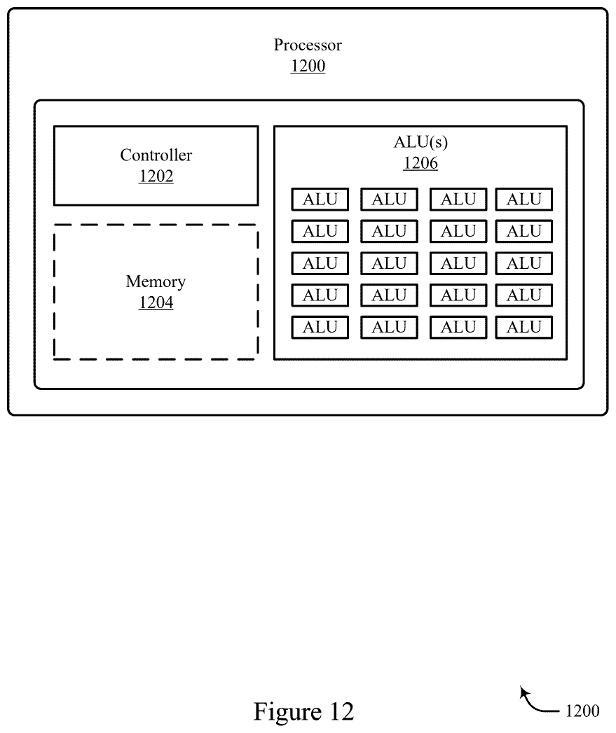

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to transmit a first message requesting an access token including a scope related to an AIMLE split operation service or an AIMLE model inference service and receive, responsive to the first message, a second message including the access token, the access token including information that identifies one or more permissions for the AIMLE split operation service or the AIMLE model inference service.

Additionally, the processor 1200 may be configured to or operable to support any one or combination of transmitting a request to perform one or more operations related to the AIMLE split operation service or the AIMLE model inference service, the request including the access token and security credentials for authentication and authorization and receiving a response that indicates whether the service device is authorized to perform the one or more operations.

Moreover, the processor 1200 may be configured to or operable to support at least one controller (e.g., the controller 1202) coupled with at least one memory (e.g., the memory 1204) and configured to cause the processor to receive a first message requesting an access token including a scope related to an AIMLE split operation service or an AIMLE model inference service, generate the access token including information that identifies one or more permissions for the AIMLE split operation service or the AIMLE model inference service, and transmit, responsive to the first message, a second message including the access token.

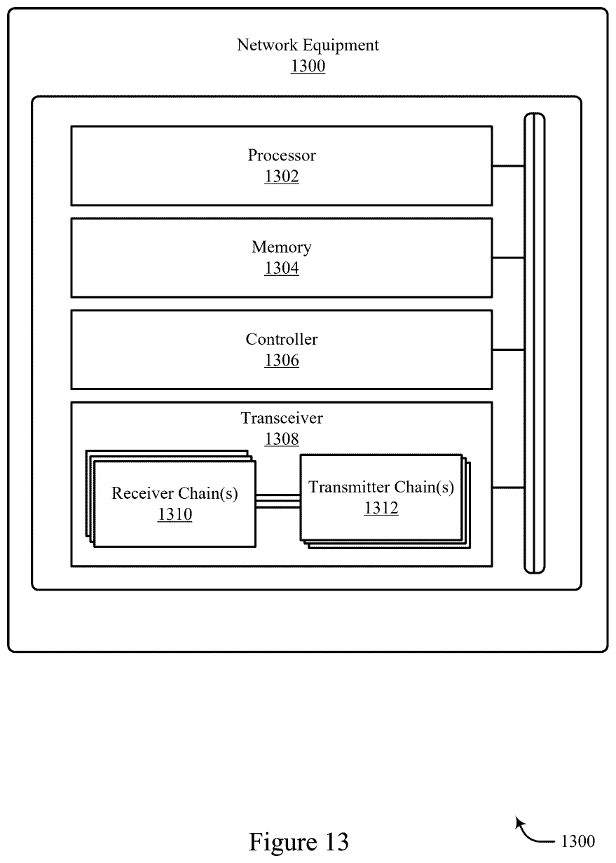

FIG. 13 illustrates an example of an NE 1300 in accordance with aspects of the present disclosure. The NE 1300 may be an example of the NE as described with reference to FIG. 1. Further, the NE 1300 may be an example of the authorization device, the service device, the AIMLE server, or the VAL server as described with reference to FIGS. 1 through 10. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to or operable to support a means for transmitting a first message requesting an access token including a scope related to an AIMLE split operation service or an AIMLE model inference service and receiving, responsive to the first message, a second message including the access token, the access token including information that identifies one or more permissions for the AIMLE split operation service or the AIMLE model inference service.

Additionally, or alternatively, the NE 1300 may support at least one memory (e.g., the memory 1304) and at least one processor (e.g., the processor 1302) coupled with the at least one memory and configured to cause the NE to transmit a first message requesting an access token including a scope related to an AIMLE split operation service or an AIMLE model inference service and receive, responsive to the first message, a second message including the access token, the access token including information that identifies one or more permissions for the AIMLE split operation service or the AIMLE model inference service.

Additionally, the NE 1300 may be configured to support any one or combination of the at least one processor configured to cause the NE 1300 to transmit a request to perform one or more operations related to the AIMLE split operation service or the AIMLE model inference service, the request including the access token and security credentials for authentication and authorization and receive a response that indicates whether the service device is authorized to perform the one or more operations.

Additionally, the NE 1300 may be configured to or operable to support a means for receiving a first message requesting an access token including a scope related to an AIMLE split operation service or an AIMLE model inference service, generating the access token including information that identifies one or more permissions for the AIMLE split operation service or the AIMLE model inference service, and transmitting, responsive to the first message, a second message including the access token.

Additionally, or alternatively, the NE 1300 may support at least one memory (e.g., the memory 1304) and at least one processor (e.g., the processor 1302) coupled with the at least one memory and configured to cause the NE to receive a first message requesting an access token including a scope related to an AIMLE split operation service or an AIMLE model inference service, generate the access token including information that identifies one or more permissions for the AIMLE split operation service or the AIMLE model inference service, and transmit, responsive to the first message, a second message including the access token.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

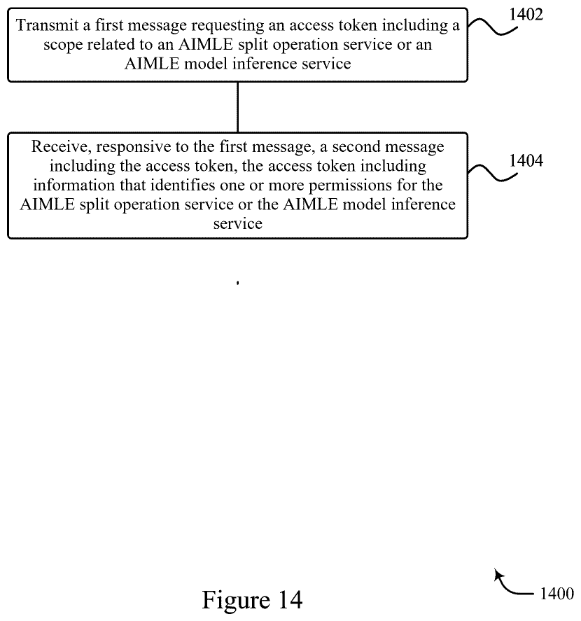

FIG. 14 illustrates a flowchart of a method 1400 in accordance with aspects of the present disclosure. The operations of the method may be implemented by a service device as described herein. In some implementations, the service device may execute a set of instructions to control the function elements of the service device to perform the described functions. It should be noted that the method described herein describes a possible implementation, and that the operations and the steps may be rearranged or otherwise modified and that other implementations are possible.

At 1402, the method may include transmitting a first message requesting an access token including a scope related to an AIMLE split operation service or an AIMLE model inference service. The operations of 1402 may be performed in accordance with examples as described herein. In some implementations, aspects of the operations of 1402 may be performed by the UE 1100 or the NE 1300 as described with reference to FIGS. 11 and 13.

At 1404, the method may include receiving, responsive to the first message, a second message including the access token, the access token including information that identifies one or more permissions for the AIMLE split operation service or the AIMLE model inference service. The operations of 1404 may be performed in accordance with examples as described herein. In some implementations, aspects of the operations of 1404 may be performed by the UE 1100 or the NE 1300 as described with reference to FIGS. 11 and 13.

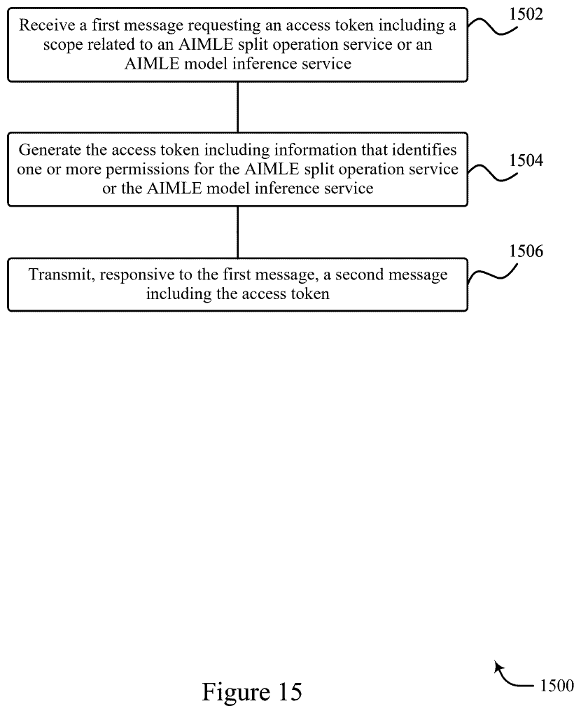

FIG. 15 illustrates a flowchart of a method 1500 in accordance with aspects of the present disclosure. The operations of the method may be implemented by an authorization device as described herein. In some implementations, the authorization device may execute a set of instructions to control the function elements of the authorization device to perform the described functions. It should be noted that the method described herein describes a possible implementation, and that the operations and the steps may be rearranged or otherwise modified and that other implementations are possible.

At 1502, the method may include receiving a first message requesting an access token including a scope related to an AIMLE split operation service or an AIMLE model inference service. The operations of 1502 may be performed in accordance with examples as described herein. In some implementations, aspects of the operations of 1502 may be performed by the NE 1300 as described with reference to FIG. 13.

At 1504, the method may include generating the access token including information that identifies one or more permissions for the AIMLE split operation service or the AIMLE model inference service. The operations of 1504 may be performed in accordance with examples as described herein. In some implementations, aspects of the operations of 1504 may be performed by the NE 1300 as described with reference to FIG. 13.

At 1506, the method may include transmitting, responsive to the first message, a second message including the access token. The operations of 1506 may be performed in accordance with examples as described herein. In some implementations, aspects of the operations of 1506 may be performed by the NE 1300 as described with reference to FIG. 13.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A service device for wireless communication, comprising:
at least one memory; and
at least one processor coupled with the at least one memory and operable to cause the service device to:
transmit a first message requesting an access token comprising a scope related to an artificial intelligence machine learning enablement (AIMLE) split operation service or an AIMLE model inference service; and
receive, responsive to the first message, a second message comprising the access token, the access token comprising information that identifies one or more permissions for the AIMLE split operation service or the AIMLE model inference service.

2. The service device of claim 1, wherein the at least one processor is further operable to cause the service device to:
transmit a request to perform one or more operations related to the AIMLE split operation service or the AIMLE model inference service, the request comprising the access token and security credentials for authentication and authorization; and
receive a response that indicates whether the service device is authorized to perform the one or more operations.

3. The service device of claim 1, wherein, responsive to the scope relating to the AIMLE split operation service and the AIMLE split operation service comprising a split operation discovery service, the first message comprises expected split operation discovery filters, expected model information, expected usage information, expected quantity of nodes to support AIML operation splitting, audience as AIMLE server identifier (ID), or any combination thereof; and
the information comprises allowed split operation discovery filters, allowed model information, allowed usage information, allowed quantity of nodes to support AIML operation splitting, audience as AIMLE server ID, issuer as authorization device ID, or any combination thereof.

4. The service device of claim 1, wherein, responsive to the scope relating to the AIMLE split operation service and the AIMLE split operation service comprising a split operation pipeline create, update, or delete service, the first message comprises expected split operation requirements, expected usage information, expected notification target, expected stage information, expected head node, expected tail node, expected node information, split operation pipeline identifier (ID), audience as AIMLE server ID, or any combination thereof; and
the information comprises allowed split operation requirements, allowed usage information, allowed notification target, allowed head node, allowed tail node, allowed node information, the split operation pipeline ID, audience as AIMLE server ID, issuer as authorization device ID, or any combination thereof.

5. The service device of claim 1, wherein, responsive to the scope relating to the AIMLE split operation service and the AIMLE split operation service comprising a split operation node registration, registration update, or de-registration service, the first message comprises expected node information, expected split operation capabilities, expected usage information, expected lifetime for registration, registration identifier (ID), audience as AIMLE server ID, or any combination thereof, and
the information comprises allowed node information, allowed split operation capabilities, allowed usage information, allowed lifetime for registration, the registration ID, audience as AIMLE server ID, issuer as authorization device ID, or any combination thereof.

6. The service device of claim 1, wherein, responsive to the scope relating to the AIMLE split operation service and the AIMLE split operation service comprising a split operation event subscription, subscription update, or unsubscription service, the first message comprises an expected split operation pipeline ID, expected notification endpoint, expected event identifier (ID), expected split operation discovery filters, expected assistance information, expected lifetime for split operation subscription, subscription ID, audience as AIMLE server ID, or any combination thereof; and
the information comprises allowed split operation pipeline ID, allowed notification endpoint, allowed event ID, allowed split operation discovery filters, allowed assistance information, allowed lifetime for split operation subscription, the subscription ID, audience as AIMLE server ID, issuer as authorization device ID, or any combination thereof.

7. The service device of claim 1, wherein, responsive to the scope relating to the AIMLE split operation service and the AIMLE split operation service comprising an AIMLE data management assistance subscription service, the first message comprises expected list of AIMLE client identifier (IDs), expected list of client set IDs, expected data management operations per client ID, client set ID, or data set ID, expected client selection criteria, audience as AIMLE server ID, audience as AIMLE client IDs, expected list of target AIMLE client IDs or client set IDs, or any combination thereof; and
the information comprises allowed list of AIMLE client IDs, allowed list of client set IDs, allowed data management operations per client ID, client set ID, or data set ID, allowed client selection criteria, audience as AIMLE server ID, audience as AIMLE client IDs, allowed list of target AIMLE client IDs or client set IDs, issuer as authorization device ID, or any combination thereof.

8. The service device of claim 1, wherein, responsive to the scope relating to the AIMLE split operation service and the AIMLE split operation service comprising a hierarchical computing assistance service, the first message comprises expected list of vertical application layer (VAL) service identifier (IDs) and corresponding expected permission levels, expected hierarchical roles for VAL server, expected computing task type, expected execution nodes, expected ML model ID list or expected ML model information for AIMLE client usage, expected hierarchical computing assistance mode, audience as edge AIMLE server ID, audience as central AIMLE server ID, or any combination thereof; and
the information comprises allowed list of VAL service IDs and corresponding allowed permission levels, allowed hierarchical roles for VAL server, allowed computing task type, allowed execution nodes, allowed ML model ID list or allowed ML model information for AIMLE client usage, allowed hierarchical computing assistance mode, audiences as edge AIMLE server ID, audience as central AIMLE server ID, issuer as authorization device ID, or any combination thereof.

9. The service device of claim 1, wherein, responsive to the scope relating to the AIMLE model inference service, the first message comprises expected list of vertical application layer (VAL) service identifiers (IDs) and corresponding expected permission levels, expected inference data type, expected inference data index, expected inference parameters, expected ML model ID, expected inference services, expected reporting types, expected address, expected ML model inference requirements, expected inference task, expected inference partitioning information, expected inference session IDs, audience as AIMLE server ID, or any combination thereof; and
the information comprises allowed list of VAL service IDs and corresponding allowed permission levels, allowed inference data type, allowed inference data index, allowed inference parameters, allowed ML model ID, allowed inference services, allowed reporting types, allowed address, allowed ML model inference requirements, allowed inference task, allowed inference partitioning information, allowed inference session IDs, audience as AIMLE server ID, issuer as authorization device ID, or any combination thereof.

10. The service device of claim 1, wherein the service device comprises one of an AIMLE client, an AIMLE server, a vertical application layer (VAL) client, or a VAL server.

11. An authorization device for wireless communication, comprising:
at least one memory; and
at least one processor coupled with the at least one memory and operable to cause the authorization device to:
receive a first message requesting an access token comprising a scope related to an artificial intelligence machine learning enablement (AIMLE) split operation service or an AIMLE model inference service;
generate the access token comprising information that identifies one or more permissions for the AIMLE split operation service or the AIMLE model inference service; and
transmit, responsive to the first message, a second message comprising the access token.

12. The authorization device of claim 11, wherein, responsive to the scope relating to the AIMLE split operation service and the AIMLE split operation service comprising a split operation discovery service, the first message comprises expected split operation discovery filters, expected model information, expected usage information, expected quantity of nodes to support AIML operation splitting, audience as AIMLE server identifier (ID), or any combination thereof, and
the information comprises allowed split operation discovery filters, allowed model information, allowed usage information, allowed quantity of nodes to support AIML operation splitting, audience as AIMLE server ID, issuer as authorization device ID, or any combination thereof.

13. The authorization device of claim 11, wherein, responsive to the scope relating to the AIMLE split operation service and the AIMLE split operation service comprising a split operation pipeline create, update, or delete service, the first message comprises expected split operation requirements, expected usage information, expected notification target, expected stage information, expected head node, expected tail node, expected node information, split operation pipeline identifier (ID), audience as AIMLE server ID, or any combination thereof; and
the information comprises allowed split operation requirements, allowed usage information, allowed notification target, allowed head node, allowed tail node, allowed node information, the split operation pipeline ID, audience as AIMLE server ID, issuer as authorization device ID, or any combination thereof.

14. The authorization device of claim 11, wherein, responsive to the scope relating to the AIMLE split operation service and the AIMLE split operation service comprising a split operation node registration, registration update, or de-registration service, the first message comprises expected node information, expected split operation capabilities, expected usage information, expected lifetime for registration, registration identifier (ID), audience as AIMLE server ID, or any combination thereof; and
the information comprises allowed node information, allowed split operation capabilities, allowed usage information, allowed lifetime for registration, the registration ID, audience as AIMLE server ID, issuer as authorization device ID, or any combination thereof.

15. The authorization device of claim 11, wherein, responsive to the scope relating to the AIMLE split operation service and the AIMLE split operation service comprising a split operation event subscription, subscription update, or unsubscription service, the first message comprises an expected split operation pipeline ID, expected notification endpoint, expected event identifier (ID), expected split operation discovery filters, expected assistance information, expected lifetime for split operation subscription, subscription ID, audience as AIMLE server ID, or any combination thereof; and
the information comprises allowed split operation pipeline ID, allowed notification endpoint, allowed event ID, allowed split operation discovery filters, allowed assistance information, allowed lifetime for split operation subscription, the subscription ID, audience as AIMLE server ID, issuer as authorization device ID, or any combination thereof.

16. The authorization device of claim 11, wherein, responsive to the scope relating to the AIMLE split operation service and the AIMLE split operation service comprising an AIMLE data management assistance subscription service, the first message comprises expected list of AIMLE client identifier (IDs), expected client set IDs, expected data management operations per client ID, client set ID, or data set ID, expected client selection criteria, audience as AIMLE server ID, audience as AIMLE client IDs, expected list of target AIMLE client IDs or client set IDs, or any combination thereof; and
the information comprises allowed list of AIMLE client IDs, allowed client set IDs, allowed data management operations per client ID, client set ID, or data set ID, allowed client selection criteria, audience as AIMLE server ID, audience as AIMLE client IDs, allowed list of target AIMLE client IDs or client set IDs, issuer as authorization device ID, or any combination thereof.

17. The authorization device of claim 11, wherein, responsive to the scope relating to the AIMLE split operation service and the AIMLE split operation service comprising a hierarchical computing assistance service, the first message comprises expected list of vertical application layer (VAL) service identifier (IDs) and corresponding expected permission levels, expected hierarchical roles for VAL server, expected computing task type, expected execution nodes, expected ML model ID list or expected ML model information for AIMLE client usage, expected hierarchical computing assistance mode, audience as edge AIMLE server ID, audience as central AIMLE server ID, or any combination thereof; and
the information comprises allowed list of VAL service IDs and corresponding allowed permission levels, allowed hierarchical roles for VAL server, allowed computing task type, allowed execution nodes, allowed ML model ID list or allowed ML model information for AIMLE client usage, allowed hierarchical computing assistance mode, audiences as edge AIMLE server ID, audience as central AIMLE server ID, issuer as authorization device ID, or any combination thereof.

18. The authorization device of claim 11, wherein, responsive to the scope relating to the AIMLE model inference service, the first message comprises expected list of vertical application layer (VAL) service identifiers (IDs) and corresponding expected permission levels, expected inference data type, expected inference data index, expected inference parameters, expected ML model ID, expected inference services, expected reporting types, expected address, expected ML model inference requirements, expected inference task, expected inference partitioning information, expected inference session IDs, audience as AIMLE server ID, or any combination thereof; and
the information comprises allowed list of VAL service IDs and corresponding allowed permission levels, allowed inference data type, allowed inference data index, allowed inference parameters, allowed ML model ID, allowed inference services, allowed reporting types, allowed address, allowed ML model inference requirements, allowed inference task, allowed inference partitioning information, allowed inference session IDs, audience as AIMLE server ID, issuer as authorization device ID, or any combination thereof.

19. A method performed by a service device, the method comprising:
transmitting a first message requesting an access token comprising a scope related to an artificial intelligence machine learning enablement (AIMLE) split operation service or an AIMLE model inference service; and
receiving, responsive to the first message, a second message comprising the access token, the access token comprising information that identifies one or more permissions for the AIMLE split operation service or the AIMLE model inference service.

20. A method performed by an authorization device, the method comprising:
receiving a first message requesting an access token comprising a scope related to an artificial intelligence machine learning enablement (AIMLE) split operation service or an AIMLE model inference service;
generating the access token comprising information that identifies one or more permissions for the AIMLE split operation service or the AIMLE model inference service; and
transmitting, responsive to the first message, a second message comprising the access token.
